(19) United States
(12) Patent Application Publication
(10) Pub. No.: US 2026/0278049 A1
(43) Pub. Date: Sep. 17, 2026

(54) Cloud-Level Physical Security Management for Cloud Infrastructure

(71) Applicant: Oracle International Corporation, Redwood Shores, CA (US)

(72) Inventors: William Nickolas Moran, Austin, TX (US); Zachary Gilburd, Seattle, WA (US); Ghazanfar Ahmed, Redmond, WA (US)

(73) Assignee: Oracle International Corporation, Redwood Shores, CA (US)

(21) Appl. No.: 19/344,226

(22) Filed: Sep. 29, 2025

Related U.S. Application Data
(60) Provisional application No. 63/771,359, filed on Mar. 13, 2025.

(51) Int. Cl. G06F 21/31

(52) U.S. Cl. CPC G06F 21/31

(57) ABSTRACT

Techniques are disclosed for managing physical access to physical computing devices based on the cloud resources that are executed and/or stored by the physical computing devices. In response to identifying a cloud resource that merits protection, the system identifies a physical computing device that executes and/or stores the cloud resource, and the system maps the physical computing device to physical security devices that can provide some form of physical security to the physical computing device. The physical security devices may include locking mechanisms, alarm mechanisms, surveillance mechanisms, and/or other physical security devices. The system then applies a physical security action to these physical security devices to configure these physical security devices to provide a level of protection to the physical computing device. The system then continues to monitor the cloud resource, the physical computing device, and/or the physical security devices for circumstances that may warrant applying another physical security action.

### BENEFIT CLAIMS; RELATED APPLICATIONS; INCORPORATION BY REFERENCE

This application claims the benefit of U.S. Provisional Patent Application 63/771,359, filed on Mar. 13, 2025, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to physical security. In particular, the present disclosure relates to physical security for computing devices.

### BACKGROUND

As used herein, the term “physical security” refers to protection from unauthorized physical access, and the term “physical security device” refers to software and/or hardware that can be configured to provide some form of physical security. For example, a physical security device may be configured to restrict, detect, deter, record, or otherwise secure a physical computing device from unauthorized physical access. Physical computing devices and/or physical security devices may be included in a facility, such as a data center, office building, industrial facility, retail facility, healthcare facility, government facility, hospitality facility, etc. The physical computing devices in any such facility may be configured for cloud computing activities.

As used herein, the term “cloud computing” refers to a model for delivering computing resources, such as processing resources, networking resources, and storage resources, in an on-demand and/or scalable manner. Cloud computing activities are facilitated by cloud resources that are executed, stored, and/or otherwise accommodated by physical computing devices. Example cloud resources include user data, application instances, virtual machines (VMs), bare metal instances, hypervisors, containerized applications, containers, block storage volumes, object storage bucks, file storage systems, database instances, operating system images, load balancers, virtual cloud networks (VCNs), gateways, and others.

There may be multiple users that should be provided physical access to at least part of a facility, such as a data center, an office building, and so forth, that includes physical computing devices configured for cloud computing activities, and the multiple users may be affiliated with separate entities. At the same time, there may be multiple users and/or multiple entities that rely on the physical computing devices in such a facility for cloud computing activities, and any given physical computing device may execute critical operations that merit a high level of availability and/or store sensitive information that warrants a high level of privacy.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment, and they mean at least one. In the drawings:

FIG. 1 illustrates a system for managing physical security in accordance with one or more embodiments;

FIG. 2 illustrates an example set of operations for applying a physical security action in response to identifying a cloud resource that warrants the physical security action in accordance with one or more embodiments;

FIG. 3 illustrates an example set of operations for applying a physical security action in response to receiving a request for some form of access to cloud infrastructure in accordance with one or more embodiments;

FIG. 4 illustrates an example set of operations for managing physical security in accordance with an example embodiment;

FIGS. 5-8 are block diagrams illustrating patterns for implementing a cloud infrastructure as a service system in accordance with one or more embodiments; and

FIG. 9 is a hardware system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The following table of contents is provided for the reader's convenience and is not intended to define the limits of the disclosure.
1. INTRODUCTION
2. GENERAL OVERVIEW
3. PHYSICAL SECURITY MANAGEMENT SYSTEM
4. CONDITION-BASED PHYSICAL SECURITY ACTIONS
5. REQUEST-BASED PHYSICAL SECURITY ACTIONS
6. EXAMPLE EMBODIMENT
7. EXAMPLES OF CLOUD INFRASTRUCTURE
8. COMPUTER SYSTEM
9. MISCELLANEOUS; EXTENSIONS

### 1. Introduction

The term “cloud computing service” or “cloud service” is generally used to refer to a service that is made available by a cloud service provider (CSP) to users or customers (referred to herein as “cloud service consumers”) on demand (e.g., via a subscription model) using systems and infrastructure (referred to herein as “cloud infrastructure”) provided by the CSP, the cloud service consumers, and/or a third-party owner, operator, and/or maintainer of the cloud infrastructure (referred to herein as a “cloud infrastructure operator”).

In most cases, the CSP is a third party that specializes in providing (e.g., offering, renting, selling, etc.) cloud services to cloud service consumers. The servers and systems that make up the CSP's infrastructure are separate from the cloud service consumer's own on-premise servers and systems. Cloud service consumers can thus avail themselves of cloud services provided by the CSP without having to purchase separate hardware and software resources for the services. Cloud services are designed to provide a subscribing cloud service consumer easy, scalable access to applications and computing resources without the cloud service consumer having to invest in procuring the infrastructure that is used for providing the services. In some instances, a cloud service consumer might opt to deploy a private cloud, becoming the cloud service consumer's own provider of cloud services. In some instances, a cloud service consumer may utilize both a private cloud and a public cloud provided by a third-party CSP, thereby forming a hybrid cloud.

There are several CSPs that offer various types of cloud services. There are various different types or models of cloud services, including Software-as-a-Service (SaaS), Platform-as-a-Service (PaaS), Infrastructure-as-a-Service (IaaS), Database as a Service (DbaaS), Function as a Service (FaaS), Anything/Everything as a Service (XaaS), and others. In an IaaS model, the CSP supplies cloud infrastructure (referred to as “cloud services provider infrastructure” or “CSPI”) that can be used by customers to build their own customizable networks and deploy customer resources.

A cloud service consumer can subscribe to one or more cloud services provided by a CSP. The cloud service consumer can be any individual user, corporation, organization, enterprise, or other entity. When a cloud service consumer subscribes to or registers for a cloud service provided by a CSP, a tenancy or an account is created for that cloud service consumer. The cloud service consumer can then, via this account, access the subscribed-to one or more cloud resources associated with the account.

### 2. General Overview

One or more embodiments configure physical security for physical computing devices based on the cloud resources that are executed and/or stored by the physical computing devices. As used herein, the term “physical security action” refers to operation(s) for managing physical security. In response to identifying a cloud resource that is to be protected, the system identifies a physical computing device that is executing and/or storing the cloud resource, and the system maps the physical computing device to physical security devices that may be configured to provide some form of physical security to the physical computing device. For instance, the system may map the physical computing device to locking mechanisms, alarm mechanisms, surveillance mechanisms, and/or other physical security devices. Note that in some cases, the cloud resource, the physical computing device, and/or the physical security devices may be managed by separate computing systems, over separate networks, and/or by separate entities. Furthermore, an entity that is associated with the cloud resource, such as a cloud service consumer, a CSP, or other entity, may have no ownership or access to a facility that includes the physical computing device and the physical security devices. For instance, the physical computing device and the physical security devices may be included in a facility that is owned and operated by a third-party cloud infrastructure operator. By mapping the physical computing device that executes and/or stores the cloud resource to the physical security devices, the system allows an entity associated with the cloud resource to manage physical security for the physical computing device at a cloud level. For instance, an entity associated with the cloud resource, such as a cloud service consumer or a CSP, may specify a level of protection that is to be provided to any given physical computing device that executes and/or stores the cloud resource. In response, the system accesses or generates a physical security policy for the cloud resource that is designed to supply the level of protection specified by the entity, and the system enforces this physical security policy on the physical computing device that executes and/or stores the cloud resource. To this end, the system traverses the mappings to identify the physical security devices that can be configured to provide some form of physical security to the physical computing device, and the system then applies a physical security action to reconfigure these physical security devices to provide the specified level of protection to the physical computing device in accordance with the physical security policy for the cloud resource.

After applying a physical security action to physical security devices that are mapped to a physical computing device that executes and/or stores a cloud resource, one or more embodiments continue to monitor the cloud resource, the physical computing, and/or the physical security devices for changes that merit applying another physical security action. For example, the system may detect the migration of the cloud resource from an old physical computing device to a new physical computing device. In response to detecting the migration of the cloud resource in this example, the system may reverse a physical security action that was previously applied to a set physical security devices mapped to the old physical computing device. Furthermore, in this example, the system identifies the new physical computing device, and the system maps the new physical computing device to another set of physical security devices that may be configured to provide some form of physical security to the new physical computing device. After identifying the other set of physical security devices in this example, the system applies another physical security action to theses physical security devices to provide an appropriate level of protection to the new physical computing device in accordance with a physical security policy for the cloud resource. As another example, assume that a physical computing device executing and/or storing the cloud resource is moved from an old physical location within a facility to a new physical location within the facility, and further assume that the new physical location is associated with different physical security devices than the old physical location. In this other example, the system detects the relocation of the physical computing device to the new physical location, and the system remaps the physical computing device to a new set of physical security devices that can be configured to provide some form of physical security to the new physical location. In addition to reversing a physical security action that was previously applied to physical security devices associated with the old physical location in this other example, the system applies a new physical security action to the new set of physical security devices to provide an appropriate level of protection to the physical computing device while the physical computing device resides at the new physical location.

In response to identifying a cloud resource that warrants protection from unauthorized physical access, one or more embodiments identify a physical computing device that executes and/or stores the cloud resource and then map the physical computing device to physical security devices that can restrict, monitor, deter, and/or otherwise secure a physical location where the physical computing device resides from unauthorized physical access. For instance, the system may identify physical pathways through a facility that lead to the physical location of the physical computing device that executes and/or stores the cloud resource, and the system may map the physical computing device to locking mechanisms on access points, such as doors, gates, elevators, and access panels, that intersect these physical pathways. Furthermore, the system may identify and then map the physical computing device to alarm mechanisms and/or surveillance mechanisms that can be configured to monitor the physical state of the physical computing device, the physical location where the physical computing device resides, and/or the physical pathways leading to this physical location. If the system subsequently receives a valid request from an entity for some form of access to the physical computing device, the system may apply a physical security action to physical security devices mapped to the physical computing device to grant the entity the requested from of access to the physical computing device. For example, an entity associated with the cloud resource, such as a cloud service consumer, a CSP, etc., may request physical access to the physical computing device to perform maintenance. If this entity's request is permissible in this example, the system selects a physical pathway that the entity will be permitted to traverse to access the physical computing device, and the system applies a physical security action to the locking mechanisms and/or alarm mechanisms mapped to the physical computing device that secures this physical pathway to the physical computing device. In this example, the physical security action reconfigures these locking mechanisms and/or alarm mechanisms, so the entity is not obstructed from traversing this physical pathway, thereby gaining physical access to the physical computing device. In another example, an entity associated with the cloud resource requests the ability to monitor physical access to the physical computing device and/or the ability to monitor the physical state of the physical computing device. In this other example, the system identifies the alarm mechanisms and/or surveillance mechanisms mapped to the physical computing device that can be configured to supply the requested form of access, and the system applies a physical security action to these alarm mechanisms and/or surveillance mechanisms to provide the entity with sufficient permissions to monitor the physical computing device through these physical security mechanisms.

One or more embodiments described in this Detailed Description and/or recited in the Claims may not be included in this General Overview section.

### 3. Physical Security Management System

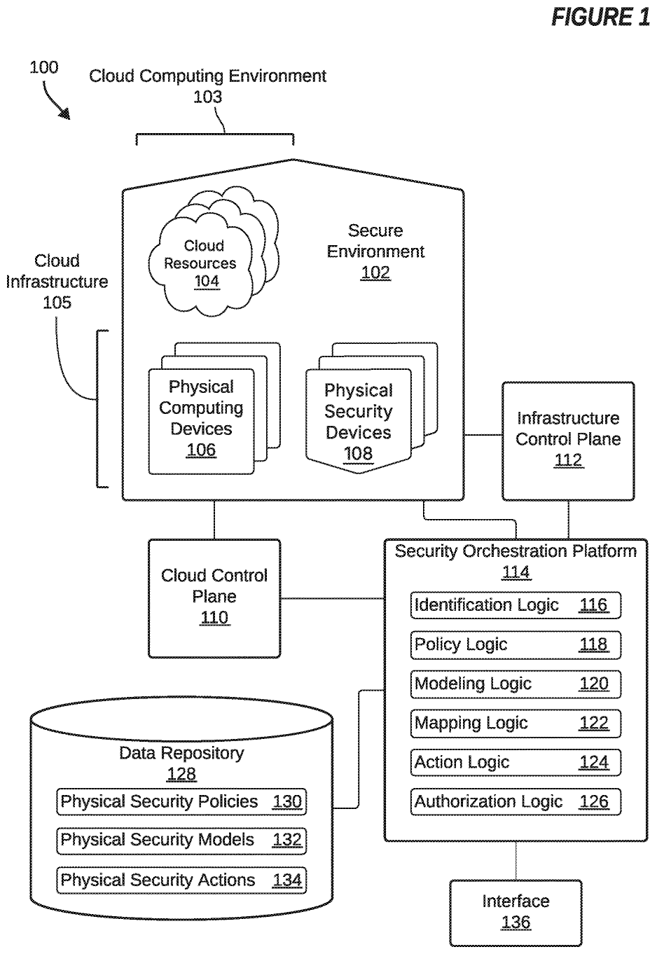

FIG. 1 illustrates a system 100 for managing physical security in accordance with one or more embodiments. As illustrated in FIG. 1, system 100 may include secure environment 102, cloud control plane 110, infrastructure control plane 112, security orchestration platform 114, data repository 128, and interface 136. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In an embodiment, techniques described herein are applied in the context of cloud computing devices and cloud computing environments. To provide consistent examples, cloud computing is used at multiple points in this Detailed Description as an example context for application of the techniques described herein. For instance, in one such example, secure environment 102 is a facility, such as a data center, that supports cloud computing activities. These examples are illustrations that are provided to aid the reader's understanding and should not be construed as limiting the scope of other embodiments. An application that is related to cloud computing is neither essential nor necessary to practice the techniques described herein. The techniques described herein are equally applicable to devices and environments other than those associated with cloud computing.

In one or more embodiments, secure environment 102 refers to any physical space that can be secured from unauthorized physical access. For instance, as illustrated in FIG. 1, a secure environment 102 may be any physical environment where (a) cloud resources 104 can be executed, stored, or otherwise accommodated by physical computing devices 106, and (b) the physical computing devices 106 can be secured from unauthorized physical access by physical security devices 108. In an example, a secure environment 102 is a compound, such as an office park, a corporate campus, a government complex, or other property. In another example, a secure environment 102 is a facility, such as a data center, office building, storage container, or other structure. In yet another example, a secure environment 102 is a compartment of a facility, such as a room, cage, cabinet, or other enclosure. A secure environment 102 may be stationary or mobile. The adjective “stationary” is used herein to qualify something whose physical location is generally static. For example, a stationary secure environment 102 may be a building, room, cabinet, cage, or other enclosure that is mechanically fixed to a physical location. The adjective “mobile” is used herein to qualify something that can be readily transferred to another physical location. For example, a mobile secure environment 102 may be a storage container, trailer, vehicle, rolling cabinet, travel trunk, or another receptible configured for ease of transportation.

In an embodiment, secure environment 102 is a data center. As used herein, the term “data center” refers to a physical environment that includes physical computing device(s) that are dedicated to processing, storing, and/or delivering data. A data center may be a stationary data center. For example, a data center may be a dedicated facility or a dedicated room of a facility. Alternatively, a data center may be a mobile data center such as a containerized data center. A data center may be an enterprise data center, a colocation data center, an edge data center, a hyperscale data center, a micro data center, a telecom data center, and/or another variety of data center.

In an embodiment, components of secure environment 102 are accessible to multiple entities. For instance, cloud resources 104, physical computing devices 106, physical security devices 108, and/or other cloud infrastructure 105 components may be remotely and/or physically accessible to multiple individuals, corporations, organizations, enterprises, or other entities. Example types of entities that may be authorized to remotely and/or physically access a component of secure environment 102 include a cloud service consumer, a CSP, a cloud infrastructure operator, and others. Note that in some cases, a cloud infrastructure operator is also a cloud service consumer or a CSP, whereas in other cases, a cloud infrastructure operator is neither a cloud service consumer nor a CSP.

In one or more embodiments, cloud computing environment 103 refers to software and/or hardware configured to deliver cloud service(s). Cloud computing environment 103 is configured to deliver a cloud service to a single cloud service consumer or multiple cloud service consumers. Example cloud services that may be delivered to a cloud service consumer by cloud computing environment 103 include SaaS, PaaS, IaaS, DbaaS, FaaS, XaaS, and others. Cloud computing environment 103 may perform critical operations for a cloud service consumer, and/or cloud computing environment 103 may include sensitive information of a cloud service consumer. Cloud computing environment 103 is managed by a single entity, such as a CSP or a cloud service consumer. Alternatively, cloud computing environment 103 is cooperatively managed by multiple entities. For example, cloud computing environment 103 may be cooperatively managed by a cloud service consumer and a CSP. Cloud computing environment 103 may be accessible to multiple entities of a given type. For example, there may be multiple cloud service consumers that can access a cloud service that is provided by cloud computing environment. As illustrated in FIG. 1, cloud computing environment 103 may include cloud resources 104 and physical computing devices 106.

In one or more embodiments, a cloud resource 104 refers to a software-defined resource that is provided, provisioned, and/or managed within a cloud computing environment 103. In general, cloud resources 104 may be configured to facilitate the delivery of cloud services by consuming underlying cloud infrastructure 105. For instance, a cloud resource 104 may be executed, stored, or otherwise accommodated by a physical computing device 106, and the physical computing device 106 may be supported by other cloud infrastructure 105 components, such as power infrastructure devices, atmospheric regulation devices, and so forth. A cloud resource 104 is accommodated by a single physical computing device 106 or multiple physical computing devices 106. Example cloud resources 104 include user data, application instances, VMs, bare metal instances, hypervisors, containerized applications, containers, block storage volumes, object storage bucks, file storage systems, database instances, operating system images, load balancers, VCNs, gateways, and others.

In one or more embodiments, cloud infrastructure 105 refers to software and/or hardware configured to facilitate cloud computing environment 103. In particular, cloud infrastructure 105 supports cloud resources 104. As illustrated in FIG. 1, cloud infrastructure 105 may include physical computing devices 106 and physical security devices 108. In addition, cloud infrastructure 105 may include other devices, such as cyber security devices, power infrastructure devices, atmospheric regulation devices, and so on. Example power infrastructure devices include generators, solar panels, wind turbines, transformers, inverters, rectifiers, switches, circuit breakers, transmission lines, uninterruptible power sources (UPSs), power distribution units (PDUs), busways, rack power distribution units (rPDUs), battery storage systems, power cables, and other devices. Example atmospheric regulation devices include computer room air conditioning (CRAC) units, computer room air handler (CRAH) units, chillers, cooling towers, in-row cooling systems, expansion units, hot/cold aisle containment systems (e.g., heating, ventilation, and air conditioning (HVAC) systems), heat exchangers, heat pumps, humidifiers, dehumidifiers, liquid cooling systems, particulate filters, and others. Cloud infrastructure 105 is managed by a single entity such as a cloud infrastructure operator. Alternatively, cloud infrastructure 105 is managed by multiple entities. For example, cloud infrastructure 105 may be cooperatively managed by a cloud infrastructure operator, a CSP, and/or a cloud service consumer. Cloud infrastructure 105 may be accessible to multiple entities of a given type. For example, a cloud infrastructure operator may vend cloud infrastructure 105 to multiple CSPs, and/or there may be separate cloud infrastructure operators for separate cloud infrastructure 105 components.

In one or more embodiments, a physical computing device 106 refers to a material device that includes software and/or hardware configured to provide computing resources for computing activities. For instance, a physical computing device 106 may be configured to execute, store, host, serve, accelerate, and/or otherwise accommodate cloud resources 104 by providing processing resources, memory resources, network resources, and/or other computing resources. Example physical computing devices 106 include physical servers, racks of servers, personal computing devices, network active gear, network passive gear, storage devices, Internet of Things (IoT) devices, hyperconverged computing nodes, Artificial Intelligence/Machine Learning (AI/ML) accelerators, edge computing devices, and others. A physical computing device 106 may be mobile or stationary. Example physical computing devices 106 that are often stationary include fixed racks of servers, mainframe computers, data center storage arrays, industrial control systems, network switches, and others. Example physical computing devices 106 that are generally mobile include wheeled racks of servers, individual physical servers, desktop computers, laptop computers, tablet computers, smart phones, phones, routers, modems, and others.

In one or more embodiments, a physical security device 108 refers to software and/or hardware that can be configured to provide some form of physical security. For instance, a physical security device 108 may be configured to provide physical security to physical computing devices 106, other cloud infrastructure 105 components, and/or physical locations within secure environment 102. A physical security device 108 may be mobile or stationary. Example types of physical security devices 108 include locking mechanisms, alarm mechanisms, surveillance mechanisms, and others. As used herein, the term “locking mechanism” refers to a physical security device 108 that can be configured to restrict physical access through an access point; the term “alarm mechanism” refers to a physical security device 108 that can be configured to trip an alarm in response to detecting some condition; and the term “surveillance mechanism” refers to a physical security device 108 that can be configured to record the state of some place and/or device. An example locking mechanism includes at least one physical lock and at least one authentication system. Example physical locks include padlocks, deadbolts, lever locks, cam locks, combination locks, mortise locks, rim locks, cylinder locks, electromagnetic locks, electronic strike locks, and others. Example authentication systems include biometric authentication systems, radio frequency identification systems, keypad entry systems, smart card authentication systems, password-based authentication systems, behavioral authentication systems, mechanical lock-and-key based authentication systems, and others. Example access points through which physical traversal may be restricted by a locking mechanism include doors, elevators, barriers, gates, mantrap entry systems, access panels, and others. Example alarm mechanisms include beam-interruption sensors, motion and proximity sensors, contact and pressure sensors, acoustic sensors, drip sensors, other environmental condition sensors, and others. Example surveillance mechanisms include CCTV cameras, automated security robots, thermal imaging cameras, audio surveillance systems, temperature sensors, humidity sensors, power consumption sensors, baseboard management controllers, and others.

In one or more embodiments, cloud control plane 110 refers to a layer of software and/or hardware configured for managing a cloud computing environment 103. For instance, cloud control plane 110 may be leveraged by a CSP and/or a cloud service consumer for managing cloud resources 104 and/or physical computing devices 106. To this end, cloud control plane 110 may include a user interface application, such as a cloud console, that can be accessed by a user to interact with other components of the cloud control plane 110. With respect to cloud resources 104 and physical computing devices 106, cloud control plane 110 may be configured for provisioning and lifecycle management, state and metadata management, policy enforcement, network and routing control, orchestration and automation, monitoring, logging, and alarming, and various other functionalities. A cloud control plane 110 may include sub-planes, such as a management plane, a compute control plane, a block volume control plane, a database control plane, a networking control plane, an identity and access management plane, and others.

In one or more embodiments, infrastructure control plane 112 refers to a layer of software and/or hardware configured for managing cloud infrastructure 105. For instance, a cloud infrastructure operator may leverage infrastructure control plane 112 to manage physical computing devices 106, physical security devices 108, power infrastructure devices, atmospheric regulation devices, and/or other cloud infrastructure 105. To this end, infrastructure control plane 110 may include a user interface application, such as a facilities application, that can be accessed by a user to interact with other components of infrastructure control plane 112.

In an embodiment, cloud control plane 110 and infrastructure control plane 112 are accessed through separate applications, run through separate computer networks, control separate components of secure environment 102, and/or are administered by separate entities. For example, cloud control plane 110 may include a cloud console that operates via a front-end network to manage cloud resources 104 and/or physical computing devices 106. Conversely, in this example, infrastructure control plane 112 may include a facilities application that operates through a facilities network to manage physical security devices 108, atmospheric devices, power infrastructure devices, and/or other cloud infrastructure 105 components. In this example, the cloud console is utilized by a CSP, and the facilities application is utilized by a colocation provider (i.e., a cloud infrastructure operator) that provides basic facilities, such as building space, HVAC, power, telecommunications access, physical security, and so on.

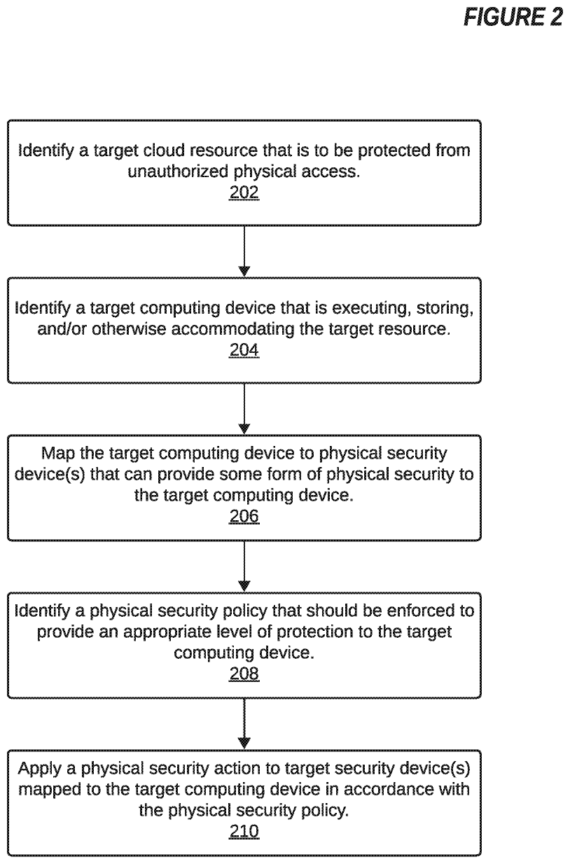

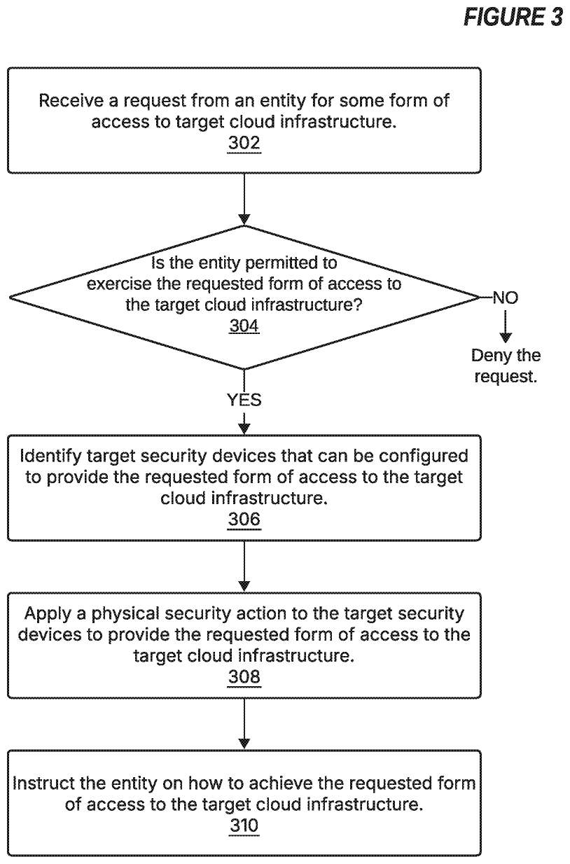

In one or more embodiments, security orchestration platform 114 refers to software and/or hardware configured for managing physical security. In general, security orchestration platform 114 is configured to manage physical security by formulating and applying physical security actions 134 to physical security devices 108. Example operations for applying physical security devices are described below with reference to FIGS. 2 and 3. Security orchestration platform 114 may be configured to manage physical security for cloud resources 104 by communicating with a cloud computing environment 103, cloud infrastructure 105, cloud control plane 110, infrastructure control plane 112, other components of system 100, and/or users of system 100. Security orchestration 114 is configured to interact with a user of system 100 via interface 136. As illustrated in FIG. 1, security orchestration platform 114 may include identification logic 116, policy logic 118, modeling logic 120, mapping logic 122, action logic 124, and authorization logic 126.

In one or more embodiments, identification logic 116 refers to executable instructions for identifying cloud resources 104 that warrant physical security actions 134. For instance, pursuant to identification logic 116, security orchestration platform 114 may be configured to identify cloud resources 104 whose circumstances merit updating the configuration of physical security devices 108 to provide an appropriate level of protection to physical computing devices 106 that execute, store, and/or otherwise accommodate the cloud resources 104. To this end, identification logic 116 may include executable instructions for monitoring the state of secure environment 102. For instance, pursuant to identification logic 116, security orchestration platform 114 may be configured to detect changes to cloud resources 104, physical computing devices 106, physical security devices 108, power infrastructure devices, atmospheric regulation devices, and/or other components of cloud infrastructure 105. To detect changes in secure environment 102, identification logic 116 may include executable instructions for communicating with components of secure environment 102, cloud control plane 110, infrastructure control plane 112, and/or other sources of information. Additionally, or alternatively, identification logic 116 may include executable instructions for monitoring user activity. For instance, pursuant to identification logic 116, security orchestration platform 114 may detect changes to physical security policies and/or respond to requests from users regarding access to components of secure environment 102.

In one or more embodiments, policy logic 118 refers to executable instructions for selecting and/or generating physical security policies 130. Pursuant to policy logic 118, security orchestration platform 114 is configured to select a predefined physical security policy 130 for a cloud resource 104, and/or security orchestration platform 114 is configured to generate a physical security policy 130 for a cloud resource 104. To obtain information that can be used to select or generate a physical security policy 130, policy logic 118 may direct orchestration platform 114 to communicate with cloud control plane 110, infrastructure control plane 112, components of secure environment 102, users of system 100, and/or other sources of information.

In one or more embodiments, modeling logic 120 refers to executable instructions for generating and/or maintaining physical security models 132. Pursuant to modeling logic 120, security orchestration platform 114 may be configured to determine associations between cloud resources 104, physical computing devices 106, physical security devices 108, components of cloud infrastructure 105, and/or physical locations within secure environment 102, and security orchestration platform 114 may be configured to embody these associations within a physical security model 132 of secure environment 102 that can be used to map cloud resources 104 to physical security devices 108. To obtain information represented in a physical security model 132, modeling logic 120 may direct security orchestration platform 114 to communicate with cloud control plane 110, infrastructure control plane 112, components of secure environment 102, users of system 100, and/or other sources of information.

In one or more embodiments, mapping logic 122 refers to executable instructions for mapping physical computing devices 106 to physical security devices 108. Pursuant to mapping logic 122, security orchestration platform 114 may be configured to map a physical computing device 106 to physical computing devices 106 that can provide some form of physical security to this physical computing device 106. Mapping logic 122 includes executable instructions for mapping physical computing devices 106 to physical security devices 108 based on physical security models 132. Additionally, or alternatively, mapping logic 122 includes executable instructions mapping cloud resources 104 to physical security devices 108 based on actively communicating with cloud control plane 110, infrastructure control plane 112, components of secure environment 102, users of system 100, and/or other sources of information.

In one or more embodiments, action logic 124 refers to executable instructions for formulating and applying physical security actions 134. Pursuant to action logic 124, security orchestration platform 114 may be configured to formulate a physical security action 134 that will provide an appropriate level of protection to a physical computing device 108, and security orchestration platform 114 may be configured to apply the physical security action 134 to the physical security devices 108 that are mapped to the physical computing device 106.

In one or more embodiments, authorization logic 126 refers to executable instructions for authorizing users to physically access a secure environment 102. Pursuant to authorization logic 124, security orchestration platform 114 may be configured to respond to a request from a user for some form of access to a physical environment 102. For example, authorization logic 126 may include executable instructions for responding to a request from a user for permission to physically access a cloud infrastructure 105 component of secure environment 102, and/or authorization logic 126 may include executable instructions for responding to a request from a user for permission to monitor a cloud infrastructure 105 component of secure environment 102. If a user has sufficient privileges to exercise a requested form of access to a cloud infrastructure 105 component of secure environment 102, authorization logic 126 may direct security orchestration platform 114 to provide the user the requested form of access via a physical security action 134 that is generated in accordance with action logic 124.

In one or more embodiments, data repository 128 is any type of storage unit and/or device (e.g., a file system, database, collection of tables, or any other storage mechanism) for storing data. Data repository 128 may include multiple different storage units and/or devices. The multiple different storage units and/or devices may or may not be of the same type or located at the same physical site. Data repository 128 may be implemented or executed on the same computing system as other components of system 100. Additionally, or alternatively, a data repository 128 may be implemented or executed on a computing system separate from other components of system 100. Data repository 128 may be communicatively coupled to other components of system 100 via a direct connection or via a network. As illustrated in FIG. 1, data repository 128 may include information describing physical security policies 130, physical security models 132, and physical security actions 134. Information describing physical security policies 130, physical security models 132, and physical security actions 134 may be implemented across any of the components within the system 100. However, this information is illustrated within the data repository 128 for purposes of clarity and explanation.

In one or more embodiments, a physical security policy 130 refers to rule(s) regarding physical security for cloud resource(s) 104. For instance, a physical security policy 130 for a cloud resource 104 may define physical security measures that should be implemented to provide an appropriate level of protection to cloud infrastructure 105 that supports the cloud resource 104. A physical security policy 130 may define physical security measures for protecting physical computing devices 106, power infrastructure devices, atmospheric regulation devices, and/or other cloud infrastructure 105 components. A physical security policy 130 for a cloud resource 104 may define physical security measures for a cloud infrastructure 105 component that supports the cloud resource 104 based on the type of the cloud resource 104, the sensitivity of the information that is included within or manipulated by the cloud resource 104, characteristics of an entity that is associated with the cloud resource 104, and/or other attributes of the cloud resource 104.

In an embodiment, a physical security policy 130 for a cloud resource 104 defines physical security measure(s) that should be implemented to provide an appropriate level of protection to a physical computing device 106 that executes, stores, or otherwise accommodates the cloud resource 104. For example, a physical security policy 130 for a compute instance, such as a VM or bare metal instance, may define physical security measures that should be implemented to protect a physical server that the compute instance is placed on. A physical security policy 130 for a cloud resource 104 may be applicable to any given physical computing device 106 that executes, stores, or otherwise accommodates the cloud resource 104. For example, if a compute instance is initially placed on one physical server, and if the compute instance is migrated to another physical server, a physical security policy 130 for the compute instance becomes applicable to the other physical server, and this physical security policy 130 may no longer be applicable to the one physical server.

In an embodiment, a physical security policy 130 for a cloud resource 104 defines physical security measure(s) that should be implemented to provide an appropriate level of security to other cloud infrastructure 105 components that support the operation of a physical computing device 106 that executes, stores, or otherwise accommodates the cloud resource 104. As an example, consider a compute instance that is placed on a physical server. In this example, a physical security policy 130 for the compute instance may define physical security measures that should be implemented to provide appropriate levels of protection to power infrastructure devices that supply electricity to the physical server, atmospheric regulation devices that regulate the operating conditions of the physical server, and/or other cloud infrastructure 105 components that support the operation of the physical server.

In an embodiment, a physical security policy 130 for a cloud resource 104 specifies a configuration for a physical security device 108 that can provide some form of physical security to a cloud infrastructure 105 component that supports the cloud resource 104. A physical security policy 130 may specify configurations for locking mechanisms, alarm mechanisms, surveillance mechanisms, and/or other physical security devices 108. A physical security policy 130 may dictate if a physical security device 108 is active, operating parameters for the physical security device 108, permissions for the physical security device 108, and/or other configuration settings for the physical security device 108.

In one or more embodiments, a physical security model 132 refers to associations(s) regarding component(s) of a secure environment 102. For instance, a physical security model 132 may define associations between cloud resources 104, physical computing devices 106, physical security devices 108, other cloud infrastructure 105 components, and/or physical locations within secure environment 102. In general, a physical security model 132 may define any association that can be used to map (a) a cloud infrastructure 105 component that supports a cloud resource 104 to (b) physical security devices 108 that can provide some form of physical security to the cloud infrastructure 105 component; in this way, the physical security model 132 may act as a means for identifying physical security devices 108 that can protect the cloud resource 104. Consider, for example, a VM that is to be afforded some degree of protection and further assume that the VM is managed by a hypervisor. In this example, a physical security model 132 may associate the hypervisor with a physical server, and the physical security model 132 may associate the physical server with physical security devices 108 that can provide some form of physical security to the physical server. Additionally, or alternatively, in this example, the physical security model 132 may associate the physical server with a physical location, and the physical security model 132 may associate that physical location with physical security devices 108 that can provide some form of physical security to that physical location.

In an embodiment, a physical security model 132 defines associations between cloud resources 104. In an example, a physical security model 132 associates an application instance with a compute instance that includes the application instance, and/or the physical security model 132 associates the compute instance with a hypervisor that manages the deployment of the compute instance. In another example, a physical security model 132 associates a pluggable data base with a container data base, and the physical security model 132 associates the container data base with a compute instance that the container data base runs on top of.

In an embodiment, a physical security model 132 defines associations between cloud resources 104 and cloud infrastructure 105 components that support the cloud resources 104. For instance, a physical security model 132 may associate a cloud resource 104 with a physical computing device 106, a physical security device 108, a power infrastructure device, an atmospheric regulation device, or another cloud infrastructure 105 component that supports the cloud resource 104. In an example, a physical security model 132 associates a compute instance with a physical server that the compute instance is placed on. In another example, a physical security model 132 associates user data with a physical storage server that stores the user data.

In an embodiment, a physical security model 132 defines associations between cloud infrastructure 105 components. For instance, a physical security model 132 may associate a cloud infrastructure 105 component with physical security devices 108 that can provide some form of physical security to the cloud infrastructure 105 component. An example physical security model 132 associates a cloud infrastructure 105 component with hierarchies of locking mechanisms attached to a series of access points that intersect physical pathways leading to the cloud infrastructure 105 component. An example physical pathway leading to a cloud infrastructure 105 component may include an access point leading into secure environment 102, access points within secure environment 102, and/or an access point on the cloud infrastructure 105 component. Furthermore, the example physical security model 132 associates the cloud infrastructure 105 component with alarm mechanisms and/or surveillance mechanisms that can monitor the physical state of the cloud infrastructure 105 component and/or the physical pathways leading to the cloud infrastructure 105 component. Additionally, or alternatively, a physical security model 132 may associate one cloud infrastructure 105 component, such as a physical computing device 106, with other cloud infrastructure 105 components that can support the operation of the one cloud infrastructure 105 component, such as power infrastructure devices, atmospheric regulation devices, and so forth.

In an embodiment, a physical security model 132 defines associations between cloud infrastructure 105 components and physical locations within secure environment 102. For instance, a physical security model 132 may associate a cloud infrastructure 105 component with a physical location where the cloud infrastructure 105 component resides. If a cloud infrastructure 105 component is mobile, a physical security model 132 may be dynamically updated to account for changes to the physical location of the cloud infrastructure 105 component. Additionally, or alternatively, a physical security model 132 associates a physical location with physical security devices 108 that can provide some form of physical security to that physical location. An example physical security model 132 associates a physical location with hierarchies of locking mechanisms attached to series of access points that intersect physical pathways leading to the physical location. Furthermore, the example physical security model 132 associates the physical location with alarm mechanisms and/or surveillance mechanisms that can monitor the physical location and/or the physical pathways leading to the physical location.

In one or more embodiments, a physical security action 134 refers to operation(s) for managing physical security. A physical security action 134 may interact with a physical security device 108. For instance, a physical security action 134 may reconfigure a physical security device 108, retrieve information recorded by the physical security device 108, analyze the information that has been recorded by the physical security device 108, and/or otherwise interact with the physical security device 108.

In an embodiment, a physical security action 134 updates the configuration of physical security device(s) 108 in accordance with a physical security policy 130 for a cloud resource 104. For instance, pursuant to a physical security policy 130 for a cloud resource 104, a physical security action 134 may activate or deactivate a physical security device 108, alter operating parameters for the physical security device 108, alter permissions for the physical security device 108, and/or otherwise alter the configuration of the physical security device 108. As an example, consider a compute instance, such as a VM or bare metal instance, that is placed on a physical server. To provide an appropriate level of protection for the physical server in this example, a physical security action 134 may reconfigure physical security devices 108 that can provide some form of physical security to the physical server in accordance with a physical security policy 130 for the compute instance.

In an embodiment, a physical security action 134 reconfigures locking mechanism(s). For instance, a physical security action 134 may engage and/or disengage locking mechanisms, alter the engagement settings for these locking mechanisms, alter permissions for engaging and/or disengaging these locking mechanisms, and/or otherwise alter the configuration of these locking mechanisms. An example physical security action 134 reconfigures hierarchies of locking mechanisms attached to series of access points that intersect physical pathways leading to a cloud infrastructure 105 component that supports a cloud resource 104.

In an embodiment, a physical security action 134 reconfigures alarm mechanism(s). For instance, a physical security action 134 may arm and/or disarm alarm mechanisms, alter the trip settings for these alarm mechanisms, alter permissions for arming and/or disarming these alarm mechanisms, and/or otherwise alter the configuration of these alarm mechanisms. An example physical security action 134 reconfigures alarm mechanisms that monitor the physical state of a cloud infrastructure 105 component, reconfigures alarm mechanisms that monitor the physical location of the cloud infrastructure 105 component, and/or reconfigures alarm mechanisms that monitor physical pathways leading to the physical location of the cloud infrastructure 105 component.

In an embodiment, a physical security action 134 reconfigures surveillance mechanism(s). For instance, a physical security action 134 may activate and/or deactivate surveillance mechanisms, alter recording settings of these surveillance mechanisms, reposition and/or reorientate these surveillance mechanisms, alter permissions for viewing the recordings of these surveillance mechanisms, and/or otherwise alter the configuration of surveillance mechanisms. An example physical security action 134 reconfigures surveillance mechanisms that monitor the physical state of a cloud infrastructure 105 component, reconfigures surveillance mechanisms that monitor the physical location of the cloud infrastructure 105 component, and/or reconfigures surveillance mechanisms that intersect physical pathways leading to the physical location of the cloud infrastructure 105 component.

In one or more embodiments, interface 136 refers to hardware and/or software configured to facilitate communications between a user and other components of system 100. Interface 136 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 136 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 136 is specified in one or more other languages, such as Java, C, or C++.

In an embodiment, system 100 is implemented on one or more digital devices. The term “digital device” generally refers to any hardware device that includes a processor. A digital device may refer to a physical device executing an application or a VM. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 4. Condition-Based Physical Security Actions

FIG. 2 illustrates an example set of operations for applying a physical security action in response to identifying a cloud resource that warrants the physical security action in accordance with one or more embodiments. One or more operations illustrated in FIG. 2 may be modified, rearranged, or omitted. Accordingly, the sequence of operations illustrated in FIG. 2 should not be construed as limiting the scope of one or more embodiments.

In one or more embodiments, the system identifies at least one cloud resource that is to be protected from unauthorized physical access (Operation 202). Hereafter, the cloud resource(s) that are identified by the system are referred to as “the target cloud resource.” The system identifies the target cloud resource on the basis that there has been some change in circumstance that calls for applying a physical security action to a physical security device associated with the target cloud resource. The system autonomously determines that the circumstances of the target cloud resource warrant a physical security action, or the system reaches this conclusion by collaborating with a user. Additionally, or alternatively, the system identifies the target cloud resource based on some other criteria for determining when to apply a physical security action. For instance, the system may identify the target cloud resource based on an interval for updating the configuration of physical security devices associated with the target cloud resource elapsing, or the system may identify the target cloud resource based on directions from a user.

In an embodiment, the system identifies the target cloud resource based on detecting the initial assignment of the target cloud resource to a physical computing device of a secure environment. The initial assignment of the target cloud resource to a physical computing device may warrant a physical security action because the physical security devices that can secure physical access to this physical computing device may need to be configured to comply with a physical security policy for the target cloud resource. As an example, assume that the target cloud resource is a compute instance, such as a VM or bare metal instance. In this example, the system identifies the compute instance as the target cloud resource based on detecting the initial placement of the compute instance onto a physical server. In another example, the system identifies an application instance as the target cloud resource based on detecting the initialization of the application instance within a compute instance. In yet another example, the system identifies sensitive user data as the target cloud resource when this sensitive user data is initially stored in persistent memory of a physical storage server.

In an embodiment, the system identifies the target cloud resource based on detecting a migration of the target cloud resource. For instance, the system may identify the target cloud resource based on detecting the migration of the target cloud resource from one physical computing device to another physical computing device. The migration of the target cloud resource from one physical computing device to another physical computing device may warrant a physical security action because the one physical computing device may be associated with other physical security devices that are different from the original physical computing device. As an example, assume that the target cloud resource is a compute instance, such as a VM or bare metal instance. In this example, the system identifies the compute instance as the target cloud resource based on detecting a migration of the compute instance from the one physical server to another physical server.

In an embodiment, the system identifies the target cloud resource based on detecting that the target cloud resource has been assigned an additional physical computing device. The assignment of an additional physical computing device to the target cloud resource may warrant a physical security action because physical security devices associated with the additional physical computing device may need to be configured to comply with a physical security policy for the target cloud resource. As an example, assume that the target cloud resource is sensitive user data stored in persistent memory of one physical storage server. In this example, the system may identify the sensitive user data as the target cloud resource based on detecting that a copy of the sensitive user data has been created and stored in the persistent memory of another physical storage server. In this example, the system may update the configuration of physical security devices associated with the other physical storage server to match the configuration of the physical security devices associated within the one physical storage server. Thus, in this example, both physical storage servers will simultaneously be provided an appropriate level of protection pursuant to a physical security policy for the target cloud resource.

In an embodiment, the system identifies the target cloud resource based on detecting a change to the state of the target cloud resource. A change to the state of the target cloud resource may warrant a physical security action because the target cloud resource may be modified in such a way that calls for supplying a greater or lesser degree of protection to a physical computing device that is executing, storing, or otherwise accommodating the target cloud resource in accordance with a physical security policy for the target cloud resource. Additionally, or alternatively, a change to the state of the target cloud resource may subject the target cloud resource to a new physical security policy. As an example, assume that the target cloud resource is a compute instance belonging to a cloud service consumer. The system identifies the compute instance as the target cloud resource in this example based on detecting that the cloud service consumer has reconfigured the compute instance for a different task. Note that in this example, the reconfiguration of the compute instance may warrant a physical security action because the different task may be associated with different information that is more or less sensitive than the information that was previously being handled by the compute instance. As another example, assume that the target cloud resource is user data of a cloud service consumer. In this other example, the system identifies the user data as the target cloud resource based on detecting that the cloud service consumer has modified the user data to include or exclude sensitive information.

In an embodiment, the system identifies the target cloud resource based on detecting that the target cloud resource has been assigned to a new user and/or a new entity. Note that different users and different entities may be associated with different physical security policies. Thus, the assignment of a new user and/or a new entity to the target cloud resource may warrant a physical security action to comply with a physical security policy associated with the new user and/or the new entity. In an example, the system identifies a compute instance as the target cloud resource based on detecting that a new principal has been permitted to access the compute instance as a result of a change that has been made to an identity and access management policy that is applicable to the compute instance.

In an embodiment, the system identifies the target cloud resource based on detecting an indication that a physical computing device accommodating the target cloud resource has been relocated to a new physical location. The relocation of a physical computing device accommodating the target cloud resource from one physical location to another physical location may warrant a physical security action because the one physical location may be associated with different physical security devices than the other physical location. The system may identify a potential physical movement of a physical computing device based on information that is obtained from the physical computing device, a cloud control plane, an infrastructure control plane, a user, and/or other sources of information. The system may detect a physical movement of a physical computing device based on some event that suggests a physical relocation of the physical computing device. For example, the system may detect a physical movement of a physical computing device based on detecting a restart of the physical computing device accompanied by a network error or loss of network connectivity. Additionally, or alternatively, the system may be directly informed of a physical movement of a physical computing device by communicating with a cloud control plane, an infrastructure control plane, the physical computing device, the physical security devices, other cloud infrastructure components, a user, or another source of information.

In an embodiment, the system identifies the target cloud resource based on detecting an anomaly associated with the target cloud resource. The system may detect an anomaly associated with the target cloud resource by communicating with a physical computing device that accommodates the target cloud resource, physical security devices that monitor the physical computing device, other cloud infrastructure components that support the physical computing device, a cloud control plane, an infrastructure control plane, a user, or another source of information. An anomaly associated with the target cloud resource may warrant a physical security action because it may be appropriate to reconfigure physical security devices, such as surveillance mechanisms, to investigate the anomaly. Furthermore, it may be appropriate to reconfigure physical security devices, such as locking mechanisms and alarm mechanisms, to increase or decrease physical security in response to an anomaly. For instance, an anomaly that suggests malicious activity may warrant increasing physical security, whereas an anomaly that calls for a user to physically access cloud infrastructure components to investigate the anomaly may warrant decreasing physical security. In an example, the system identifies the target cloud resource based on a drip sensor associated with a physical computing device accommodating the target cloud resource detecting water intrusion. In another example, the system identifies the target cloud resource based on a camera detecting an individual loitering in physical proximity to a physical computing device that accommodates the target cloud resource. Other examples of anomalies that may warrant a physical security action include a performance degradation, an increase in errors, an increase in temperature, an increase in power consumption, a loose cable, a loss of network connectivity, a loss of power, and other abnormal conditions.

In an embodiment, the system identifies the target cloud resource based on detecting an update to a physical security model. An update to the physical security model may warrant a physical security action because an update to the physical security model may change the physical security devices that are directly or indirectly associated with a physical computing device that accommodates the target cloud resource. In other words, an update to the physical security model may be the result of some change in the target cloud resource's circumstances that alters the composition of the physical security device that are capable of protecting the target cloud resource from unauthorized physical access. In an example, the system identifies the target cloud resource based on an update to the physical security model that directly associates a physical computing device that is executing, storing, and/or otherwise accommodating the target cloud resource with a new physical security device. In another example, the system identifies the target cloud resource based on an update to the physical security model that associates a physical computing device accommodating the target cloud resource with a new physical location.

In an embodiment, the system identifies the target cloud resource based on detecting an update to a physical security policy that is applicable to the target cloud resource. For instance, the system may identify the target cloud resource based on detecting (a) a modification to an existing physical security policy for the target cloud resource, (b) the creation of a new physical security policy for the target cloud resource, or (c) the deletion of an old physical security policy for the target cloud resource. An update to a physical security policy for the target cloud resource may warrant a physical security action because this update may correspond to an increase or decrease in the level of protection that should be provided to a physical computing device that is executing, storing, and/or otherwise accommodating the target cloud resource. Additionally, or alternatively, an update to a physical security policy for the target cloud resource may alter the physical security measures that should be implemented to provide an appropriate level of protection to a physical computing device that is accommodating the target cloud resource.

In an embodiment, the system identifies the target cloud resource based on detecting the termination of the target cloud resource. If the target cloud resource is terminated, then a physical computing device may no longer be entitled to a level of protection that is stipulated by a physical security policy for the target cloud resource. Thus, the termination of the target cloud resource may warrant a physical security action.

In one or more embodiments, the system identifies the physical computing device(s) that are executing, storing, and/or otherwise accommodating the target cloud resource (Operation 204). Note that if there are multiple physical computing devices that accommodate the target cloud resource, these multiple physical computing devices may be associated with different physical security devices and/or included in different secure environments. Hereafter, the physical computing device(s) accommodating the target cloud resource that are identified by the system are referred to as “the target computing device,” and the secure environment(s) that include the target computing device are referred to as “the target environment.” In general, the system identifies the target computing device by obtaining some identifier and/or description of the target computing device. In identifying the target computing device, the system may ascertain additional characteristics of the target computing device that can be used to map the target computing device to physical security devices of the target environment. For instance, the system may ascertain the physical location of the target computing device within the target environment. The system identifies the target computing device autonomously, or the system identifies the target computing device by collaborating with a user.

In an embodiment, the system identifies the target computing device by communicating with a cloud control plane that manages the deployment of cloud resources on physical computing devices of the target environment. As an example, assume that the target cloud resource is a compute instance, such as a VM or bare metal instance, that has been placed on a physical server (i.e., the target computing device) of a data center (i.e., the target environment). In this example, the system may identify the physical server based on placement metadata that is obtained from a compute control plane of a CSP that handles the placement of compute instances on physical servers of the data center.

In an embodiment, the system identifies the target computing device based on a physical security model of the target environment. As an example, assume that the target cloud resource is a VM. In this example, the physical security model associates the VM with a physical server that the VM is running on. Additionally, or alternatively, the physical security model of this example associates the VM with a hypervisor, and the physical security model associates the hypervisor with the physical server.

In one or more embodiments, the system maps the target computing device to at least one physical security device that can provide some form of physical security to the target computing device (Operation 206). Additionally, or alternatively, the system maps the target computing device to at least one physical security device that can provide some form of protection to another cloud infrastructure component of the target environment that is supporting the operation of the target computing device. Example physical security devices that may be mapped to the target computing device include locking mechanisms, alarm mechanisms, surveillance mechanisms, and other physical security devices. The system maps the target computing device to a physical security device based on a physical security model of the target environment. Additionally, or alternatively, the system maps the target computing devices to a physical security device by communicating with the cloud control plane of the target environment, an infrastructure control plane of the target environment, the target computing devices, a user, and/or other sources of information. The system autonomously maps the target cloud resource to a physical security device, and/or the system maps the target cloud resource to a physical security device by collaborating with a user.

In an embodiment, the system maps the target computing resource to a locking mechanism that can restrict physical access to the target computing device. For instance, the system may identify physical pathways through the target environment that can be traversed to reach the physical location of the target computing device and/or gain physical access into the target computing device, and the system may map the target computing device to hierarchies of locking mechanisms that are affixed to series of access control points that intersect these physical pathways. As an example, assume that the target computing device is a physical server that is included in a rack of servers within a data center. In this example, the system may map the target computing device to any of the following: a locking mechanism on an entrance to data center, locking mechanisms on doors and/or elevators that lead to a room of the data center where the particular server is located, a locking mechanism on a gate of a cage that surrounds a rack of servers that includes the physical server, and a locking mechanism on the chassis of the physical server.

In an embodiment, the system maps the target computing resource to an alarm mechanism that can monitor the target computing device. For instance, the system may map the target computing device to alarm mechanisms that monitor the physical state of the target computing, alarm mechanisms that monitor the physical location of the target computing device, and/or alarm mechanisms that monitor physical pathways leading into the target computing device. As an example, assume that the target computing device is a physical server that is located in a room of a data center. In this example, the system maps the target cloud resource to a contact sensor on a door frame of a door that leads into the room of the data center where the physical server is located, a motion sensor that is configured to detect motion in this room of the data center, and a tamper switch on the chassis of the physical server that is configured to detect the removal of an access panel of the physical server.

In an embodiment, the system maps the target computing device to a surveillance mechanism that can monitor the target computing device. For instance, the system may map the target computing device to surveillance mechanisms that can monitor the physical state of the target computing device, surveillance mechanisms that can monitor the physical location of the target computing device, and/or surveillance mechanisms that can monitor physical pathways that lead to the target computing device. As an example, assume that the target computing device is a physical server that is located in a room of a data center. In this example, the system maps the target cloud resource to a CCTV camera that can be reorientated to monitor a door into the room of the data center where the physical sever is located, a CCTV camera in the room of the data center that can be reorientated to monitor the physical server, and a baseboard management controller included in the physical server that can be used to monitor CPU temperatures, fan speeds, power supply voltages, and other operating conditions of the physical server.

In an embodiment, the system maps the target computing device to a physical security device based on a physical security model of the target environment. The physical security model directly associates a physical computing device with physical security devices that can provide some form of physical security to the physical computing device. For instance, the physical security model may directly associate the target computing device with locking mechanisms, alarm mechanisms, surveillance mechanisms, and/or other physical security devices. Additionally, or alternatively, the physical security model directly associates a physical location within the target environment with physical security devices that can provide some form of physical security to that physical location. For instance, the physical security model may directly associate the target computing device's present physical location with locking mechanisms, alarm mechanisms, surveillance mechanisms, and/or other physical security devices. As an example, assume that the target computing device is a physical server in a room of the data center. In this example, the physical security model directly associates the physical server with a baseboard management controller that is included in the physical server, and the physical security model directly associates the physical server with a locking mechanism on the chassis of the physical server. Furthermore, in this example, the physical security model directly associates the present physical location of the physical server with other physical security devices, such as a locking mechanism on a cage that surrounds a rack of servers that includes the physical server, a locking mechanism on a door into the room that includes the rack of servers, a locking mechanism on an entrance into the data center, a CCTV camera in the room of the data center, a motion sensor in the room of the data center, and/or other physical security devices. In this way, the physical security model of this example indirectly associates the physical server with these other physical security devices.

In an embodiment, the system maps the target cloud resource to a physical security device that can provide some form of physical security to a cloud infrastructure component that is supporting the operation of the target computing device. Note that providing physical security to a cloud infrastructure components that support the operation of the target computing device indirectly provides a level of protection to the target computing device. The system may map the target computing device to physical security devices that can provide some form of physical security to power infrastructure devices, atmospheric regulation, or other cloud infrastructure components that support the operation of the target computing device. As an example, assume that the target computing device is a physical server in a data center. In this example, the system may map the physical server to a physical security device that can provide some form of physical security to a generator block, an uninterruptible power supply, a power distribution unit, a busway, or another cloud infrastructure component that directly or indirectly supplies electricity to the physical server.

In an embodiment, the system maps the target cloud resource to a physical security device based on communicating with an infrastructure control plane that manages cloud infrastructure in the target environment. As an example, assume that the target cloud resource is a compute instance that has been placed on a physical server of a data center. For the purposes of this example, further assume that the system has learned the identity of the host server based on placement metadata obtained from a compute control plane of a CSP. Based on an identifier of the physical server included in the placement metadata in this example, the system communicates with the infrastructure control plane of the data center to identify the physical location of the host server within the data center, the physical security devices in the data center that can provide physical security to the physical server, the cloud infrastructure components that support the physical server, the physical security devices that can provide physical security to these other cloud infrastructure components, and/or other information.

In one or more embodiments, the system identifies a physical security policy for the target cloud resource that should be enforced to provide an appropriate level of protection to the target computing device (Operation 208). In particular, the system accesses a predefined physical security policy for the target cloud resource, or the system generates a new physical security policy for the target resource. The physical security policy may define physical security measures that should be implemented to provide an appropriate level of protection to the target computing device, and/or the physical security policy may define configurations for physical security devices that should be enacted to implement these physical security measures. The physical security policy may define configurations for locking mechanisms, alarm mechanisms, surveillance mechanisms, and/or other physical security devices. The system autonomously identifies the physical security policy for the target cloud resource, or the system identifies the physical security policy for the target cloud resource by collaborating with a user.

In one or more embodiments, the system applies a physical security action to at least a subset of the physical security devices that are mapped to the target computing device (Operation 210). Hereafter, the physical security device(s) that are subjected to the physical security action are referred to as “the target security devices.” The target security devices may include locking mechanisms, alarm mechanisms, surveillance mechanisms, and/or other physical security devices. In accordance with the physical security policy for the target cloud resource, the physical security action may activate or deactivate target security devices, alter operating parameters for target security devices, alter permissions for the target security devices, reposition or reorientate target security devices, and/or otherwise alter the configuration of the target security devices to sufficiently protect the target computing device and/or other cloud infrastructure components that support the operation of the target computing device. Additionally, or alternatively, the physical security action may access and/or analyze recordings of the target security devices. For instance, the physical security action may access and/or analyze recordings of the target security devices to respond to an anomaly associated with the target cloud resource.

In an embodiment, the physical security action reconfigures a locking mechanism that is mapped to the target computing device. For instance, pursuant to a physical security policy for the target cloud resource, the physical security action may reconfigure hierarchies of locking mechanisms on series of access points that intersect physical pathways leading to a physical location of the target computing device. Among other configuration changes, the physical security action may activate or deactivate these locking mechanisms, alter the engagement settings for these locking mechanisms, and/or define what credentials can be used to engage or disengage these locking mechanisms. In this way, the physical security action may allow an authorized user to fully traverse these physical pathways to physically access the target computing device while preventing unauthorized users from achieving the same. Additionally, or alternatively, the physical security action may configure other hierarchies of locking mechanisms on other series of access points that intersect other physical pathways leading to physical locations of other cloud infrastructure components that support the operation of the target computing device.

In an embodiment, the physical security action retrieves previous recordings of locking mechanisms that are mapped to the target computing device. For instance, the physical security action may retrieve records of credentials that have been used to disengage a hierarchy of locking mechanisms attached to a series of access points that intersect a physical pathway leading to the physical location of the target computing device. Furthermore, the physical security action may analyze these recordings to determine who has accessed the target computing device, and/or the physical security action may provide these recordings and/or this analysis to a user.

In an embodiment, the physical security action reconfigures an alarm mechanism that is mapped to the target computing. For instance, pursuant to the physical security policy for the target cloud resource, the physical security action may reconfigure alarm mechanisms that monitor the physical state of the target computing device, alarm mechanisms that monitor the physical location of the target computing device, and/or alarm mechanism that monitor physical pathways leading to the physical location of the target computing device. Among other configuration changes, the physical security action may arm and/or disarm these alarm mechanisms, alter the trip settings for these alarm mechanisms, reposition and/or reorientate these alarm mechanisms, and/or alter permissions for arming and/or disarming these alarm mechanism. As a result of these changes, an authorized user may be able to physically access the target computing device without triggering an alarm mechanism, and an unauthorized user may be unable to physically access the target computing device without triggering an alarm mechanism. Additionally, or alternatively, the physical security action may configure other alarm mechanisms that monitor other cloud infrastructure components that support the operation of the target computing device.

In an embodiment, the physical security action retrieves previous recordings of alarm mechanisms that are mapped to the target computing device. Furthermore, the physical security action may analyze these recordings, and the physical security action may provide these recordings and/or this analyses to a user.

In an embodiment, the physical security action reconfigures a surveillance mechanism that is mapped to the target computing device. For instance, the physical security action may reconfigure surveillance mechanisms to monitor the target computing device. Pursuant to a physical security policy for the target cloud resource, the physical security action may reconfigure surveillance mechanisms that monitor the physical state of the target computing device, surveillance mechanisms that monitor the physical location of the target computing device, and/or surveillance mechanisms that monitor physical pathways leading to the physical location of the target computing device. Among other configuration changes, the physical security action may activate or deactivate these surveillance mechanisms, alter the recording settings for these alarm mechanisms, reposition and/or reorientate these surveillance mechanisms, and/or alter permissions for viewing the recordings of these surveillance mechanisms. The physical security action may configure a surveillance mechanism to continuously monitor the target computing device, and/or the physical security action may configure a surveillance mechanism to monitor the target computing device in certain circumstances. Additionally, or alternatively, the physical security action may configure other surveillance mechanisms that can monitor other cloud infrastructure components that support the operation of the target computing device.

In an embodiment, the physical security action retrieves previous recordings of surveillance mechanisms that are mapped to the target computing device. For instance, the physical security action may retrieve recordings of surveillance mechanisms monitoring the target computing device in response to detecting some anomaly associated with the target computing device. Furthermore, the physical security action may analyze these recordings to investigate the anomaly, and the physical security action may provide these recordings and/or this analysis to a user.

### 5. Request-Based Physical Security Actions

FIG. 3 illustrates an example set of operations for applying a physical security action in response to receiving a request for some form of access to cloud infrastructure in accordance with one or more embodiments. One or more operations illustrated in FIG. 3 may be modified, rearranged, or omitted. Accordingly, the sequence of operations illustrated in FIG. 3 should not be construed as limiting the scope of one or more embodiments.

In one or more embodiments, the system receives a request from an entity for some form of access to a target cloud infrastructure (Operation 302). Hereafter, the cloud infrastructure that the entity is requesting some form of access to is referred to as “the target cloud infrastructure.” The target cloud infrastructure may include physical computing devices, physical security devices, power infrastructure devices, atmospheric regulation devices, and/or other cloud infrastructure components. The entity that is requesting access to the target cloud infrastructure is a cloud service consumer, a CSP, a cloud infrastructure operator, and/or some other type of entity. The entity is requesting physical access to the target cloud infrastructure. For example, the entity may be requesting physical access to the target cloud infrastructure to perform maintenance. Additionally, or alternatively, the entity is requesting the ability to monitor the target cloud infrastructure. The target cloud infrastructure is included in at least one secure environment that is referred to hereafter as “the target environment.”

In an embodiment, the entity is requesting physical access to the target cloud infrastructure. The entity may be requesting physical access for itself and/or for another entity. In an example, the entity is a cloud service consumer, and the cloud service consumer is requesting physical access to a physical server (i.e., the target cloud infrastructure) that is executing, storing, and/or otherwise accommodating a cloud resource belonging to the cloud service consumer. In another example, the entity is a cloud infrastructure operator, and the entity is requesting physical access to power infrastructure devices (i.e., the target cloud infrastructure) in a data center. In this other example, the data center is operated by another cloud infrastructure operator.

In an embodiment, the entity is requesting the ability to monitor the target cloud infrastructure. For instance, the entity may be requesting the ability to monitor physical access to the target cloud infrastructure, and/or the entity may be requesting the ability to monitor the state of the target cloud infrastructure. In an example, the entity is a cloud service consumer, and the cloud service consumer is requesting the ability to monitor a physical server that executes, stores, and/or otherwise accommodates a compute instance belonging to the cloud service consumer via surveillance mechanisms and/or alarm mechanisms that can be configured to monitor the physical server.

In one or more embodiments, the system determines if the entity is authorized to exercise the requested form of access to the target cloud infrastructure, and the system may proceed to another operation based on this determination (Operation 304). The system autonomously determines if the entity is authorized to exercise the requested form of access to the target cloud infrastructure. Additionally, or alternatively, the system determines if the entity is authorized to exercise the requested form of access to the target cloud infrastructure by collaborating with a user. If the entity is authorized to exercise the requested form of access to the target cloud infrastructure, the system proceeds to Operation 306. Alternatively, if the entity is not permitted to exercise the requested form of access to the target cloud infrastructure, the system denies the entity's request.

In an embodiment, the system determines if the entity is authorized to exercise the requested form of access to the target cloud infrastructure based on a physical security policy for a cloud resource that is supported by the target cloud infrastructure. In some cases, the target cloud infrastructure may be supporting multiple cloud resources. In an example, a physical security policy for a cloud resource supported by the target cloud infrastructure defines a list of entities that are permitted to access the target cloud infrastructure. Furthermore, with respect to any given entity that the physical security policy permits to access the target cloud infrastructure in this example, the physical security policy may further define permissible forms of access to the target cloud infrastructure, permissible times for accessing the target cloud infrastructure, permissible procedures for accessing the target cloud infrastructure, other entities that should be notified of access to the target cloud infrastructure, security measures that should be implemented while access is being provided to the target cloud infrastructure, and/or other parameters for accessing the target cloud infrastructure.

In an embodiment, the system determines if the entity is authorized to exercise the requested form of access to the target cloud infrastructure based on querying another entity for approval of the entity's request. The system may identify another entity that should be queried for approval of the entity's request based on agreed upon relationships between the entities, such as those that may be defined in service level agreements, ownership of cloud resources that are supported by the target cloud infrastructure, ownership of the target cloud infrastructure, ownership of the target environment, and/or other information. As an example, assume that the entity is a cloud service consumer that is requesting access to a physical server (i.e., the target cloud infrastructure) that accommodates a cloud resource of the cloud service consumer. In this example, the system may query a CSP of the cloud resource, a cloud service operator of the target cloud infrastructure, and/or another cloud service consumer that is reliant on the target cloud infrastructure. In another example, the entity is a CSP, and the system queries a cloud service consumer of a cloud resource that is supported by the target cloud infrastructure, a cloud infrastructure operator of the target cloud infrastructure, and/or another CSP that utilizes the target cloud infrastructure to provide a cloud service. In yet another example, the entity is a cloud infrastructure operator, and the system queries a cloud service consumer of a cloud resource that is supported by the target cloud infrastructure, a CSP of the cloud resource, and/or another cloud infrastructure operator of cloud infrastructure in the target environment.

In one or more embodiments, the system identifies physical security device(s) that can be configured to provide the requested form of access to the target cloud infrastructure (Operation 306). Hereafter, the physical security device(s) that can be configured to provide the requested form of access to the target cloud infrastructure are referred to as “the target security devices.” The target security devices may include locking mechanisms, alarm mechanisms, surveillance mechanisms, and/or other types of physical security devices. In general, the target security devices that are identified by the system will depend on (a) the target cloud infrastructure that the entity is seeking to access and (b) the form of access that the entity is requesting.

In an embodiment, the entity is requesting physical access to the target cloud infrastructure, and the system identifies the target security devices based on a physical security model of the target environment. For example, the system may identify the target security devices by determining the physical security devices that the physical security model associates with the target cloud infrastructure. In another example, the system identifies the target security devices by determining the physical location of the target cloud infrastructure and then determining what physical security devices the physical security model associates with this physical location.

In an embodiment, the entity is requesting physical access to the target cloud infrastructure, and the system identifies the target security devices based on selecting at least one physical pathway that the entity should be permitted to traverse to physically access the target cloud infrastructure. Hereafter, the physical pathway(s) that the entity will be permitted to traverse to physically access the target cloud infrastructure are referred to as “the target route.” After identifying the target route, the system identifies target security devices by determining what physical security devices in the target environment may need to be configured to allow the entity to successfully traverse the target route to gain physical access to the target cloud infrastructure. For instance, the target security devices may include locking mechanisms on access points that intersect the target route, and/or the target security devices may include alarm mechanisms that can be configured to trigger an alarm in response to detecting traversal through the target route. Note that there may be multiple physical pathways that can be traversed to reach the target cloud infrastructure, and the multiple physical pathways may be protected by different physical security devices. Thus, the target security devices may vary depending on the target route that is selected by the system. Accordingly, the system may optimize the target route to avoid granting the entity undue physical access to the target environment. For instance, the system may optimize the target route to (a) be direct as possible, (b) avoid areas of the target environment that include other cloud infrastructure components that support sensitive cloud resources of other entities, (c) minimize the number locking mechanisms that will be disengaged to allow the entity physical access to the target cloud infrastructure, and/or (d) minimize the number of alarm mechanisms that will be disarmed to provide the entity physical access to the target cloud infrastructure.

In an embodiment, the entity is requesting the ability to monitor the target cloud infrastructure, and the system identifies physical security devices, such as alarm mechanisms and surveillance mechanisms, that can be used to monitor the target cloud infrastructure. As an example, assume that the entity is requesting the ability to monitor a physical server included in a room of a data center. In this example, the system may identify any of the following: a CCTV camera that can be used to monitor an access point into the room of the data center; a CCTV camera within the room of the data center that can be reorientated to view the physical server; a motion detector in the room of the data center; a tamper switch on the chassis of the physical server; a baseboard management controller included in the physical server that can be used to monitor CPU temperatures, fan speeds, power supply voltages, and other operating conditions of the physical server; and/or other physical security devices that can be used to monitor physical access to the physical server and/or the state of the physical server.

In one or more embodiments, the system applies a physical security action to the target security devices to provide the requested form of access to the target cloud infrastructure (Operation 308). The system may formulate the physical security action in accordance with any physical security policies for any cloud resources that are being supported by the target cloud infrastructure. The physical security action may activate or deactivate target security devices, alter operating parameters for target security devices, alter permissions for the target security devices, and/or otherwise alter the configuration of the target security devices to provide the requested form of access to the target cloud infrastructure.

In an embodiment, the entity is requesting physical access to the target cloud infrastructure, and the physical security action reconfigures locking mechanisms that restrict access to the target cloud infrastructure. For instance, the physical security action may reconfigure a hierarchy of locking mechanisms on a series of access points that intersect the target route to the target cloud infrastructure. The physical security action may disengage these locking mechanisms when the entity arrives at the target environment, and/or the physical security action may reconfigure these locking mechanisms to permit the entity to disengage these locking mechanisms. The physical security action may refrain from reconfiguring other locking mechanisms on other access points that do not intersect the target route. As a result, a user that is authorized to physically access the target cloud infrastructure pursuant to the entity's request may be prevented from physically accessing other cloud infrastructure within the target environment. As an example, assume that the target cloud infrastructure is a physical server included in a rack of servers that is located within a room of a data center. Following the physical security action in this example, an authorized user is able to disengage the following: a locking mechanism on an entrance to the data center; a locking mechanism on a door into the room of the data center where the physical server is located; a locking mechanism on a gate of a cage that surrounds the racks of servers that includes the physical server; and a locking mechanism on the chassis of the physical server. However, following the physical security action in this example, the authorized user is unable to disengage locking mechanisms on doors that lead into other rooms of the data center, locking mechanisms on other gates of other cages that surround other racks of servers that are located in the same room as the physical server, or locking mechanisms on the chassis of other physical servers that are included in the same rack of servers as the physical server.

In an embodiment, the entity is requesting physical access to the target cloud infrastructure, and the physical security action reconfigures alarm mechanisms that can be configured to activate an alarm upon detecting an unauthorized attempt to physically access the target cloud infrastructure. For instance, the physical security action may disarm these alarm mechanisms when the entity arrives at the target environment, and/or the physical security action may reconfigure these alarm mechanisms to permit the entity to disarm these alarm mechanisms. As a result, a user that is authorized to physically access the target cloud infrastructure in response to the entity's request is able to reach the target cloud infrastructure without triggering an alarm mechanism. The physical security action may refrain from reconfiguring other alarm mechanisms that monitor cloud infrastructure other than the target cloud infrastructure. Consequently, the authorized user may be unable to physically access other areas and other devices in the target environment without triggering an alarm mechanism.

In an embodiment, the entity is requesting the ability to monitor the target cloud infrastructure, and the physical security action reconfigures locking mechanisms, so the entity can view what credentials of what users have been used to physically access the target cloud infrastructure.

In an embodiment, the entity is requesting the ability to monitor the target cloud infrastructure, and the physical security action reconfigures alarm mechanisms that can be configured to activate an alarm upon detecting an unauthorized attempt to physically access the target cloud infrastructure. For instance, the physical security action may reconfigure these alarm mechanisms to transmit alarms to the entity.

In an embodiment, the entity is requesting the ability to monitor the target cloud infrastructure, and the physical security action reconfigures surveillance mechanisms that can be configured to observe the target cloud infrastructure. For instance, the physical security action may activate these surveillance mechanisms, reorient these surveillance mechanisms to monitor the target cloud infrastructure, and/or permit the entity to access the recordings of these surveillance mechanisms. As a result of these changes, the entity may be permitted to monitor the target cloud infrastructure through these surveillance mechanisms. The physical security action may refrain from reconfiguring other surveillance mechanisms that cannot be used to monitor the target cloud infrastructure. Consequently, the entity may be unable to monitor other areas and other devices of the target environment.

In one or more embodiments, the system instructs the entity on how to achieve the requested form of access to the target cloud infrastructure (Operation 310). For instance, the system may provide the entity with credentials that can be used to obtain the requested form of access to the target cloud infrastructure, and/or the system may provide the entity with instructions for how to use these credentials to obtain the requested form of access to the target cloud infrastructure.

In an embodiment, the entity is requesting physical access to the target cloud infrastructure, and the system instructs the entity on how to traverse the target route to the target cloud infrastructure. For instance, the system may transmit a message to the entity that describes the physical location of the target cloud infrastructure, and the system may instruct the entity on how to traverse the target route to reach the target cloud infrastructure. The system may provide verbal instructions for traversing the target route, and/or the system may provide a map of the target route. Additionally, or alternatively, the system provides the entity with credentials that can be used to disengage locking mechanisms attached to access points that intersect the target route, and the system instructs the entity on how to use these credentials to traverse the target route.

In an embodiment, the entity is requesting the ability to monitor the target cloud infrastructure, and the system instructs the entity on how to monitor the target cloud infrastructure through the target security devices. For instance, the system may provide the entity with credentials that can be used to remotely access recordings of alarm mechanisms and/or surveillance mechanisms that have been reconfigured by the physical security action, and/or the system may provide the entity with instructions for accessing these recordings.

### 6. Example Embodiment

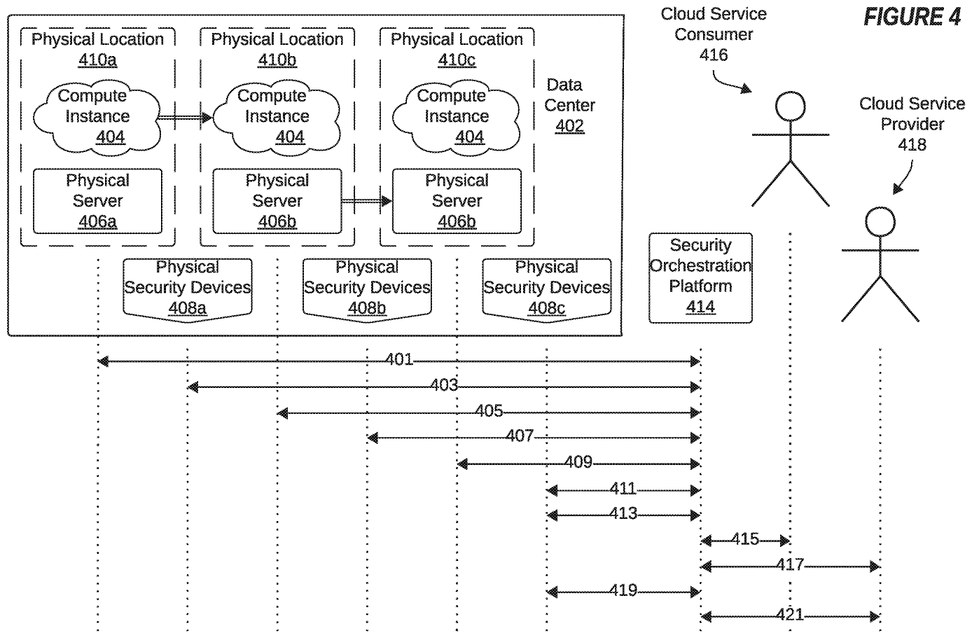

FIG. 4 illustrates an example set of operations for managing physical security in accordance with an example embodiment. A detailed example is described below for purposes of clarity. Components and/or operations described below should be understood as one specific example that may not be applicable to certain embodiments. Accordingly, components and/or operations described below should not be construed as limiting the scope of any of the claims.

In an example embodiment, security orchestration platform 414 detects the initial deployment of a compute instance 404 that is to be protected from unauthorized physical access, and the security orchestration platform 414 identifies a physical server 406a in a data center 402 that the compute instance 404 has been placed on (Operation 401). In addition to identifying the compute instance 404 and the physical server 406a, the security orchestration platform 414 accesses or generates a physical security policy for the compute instance 404, and the security orchestration platform 414 determines the physical location 410a of the physical server 406a within data center 402.

In an example embodiment, security orchestration platform 414 maps the physical server 406a to physical security devices 408a, and the security orchestration platform 414 applies a first physical security action to these physical security devices 408a to provide an appropriate level of protection to the physical server 406a in accordance with the physical security policy for compute instance 404 (Operation 403). The security orchestration platform 414 maps the physical server 406a to physical security devices 408a on the basis that these physical security devices 408a can provide some form of physical security to physical server 406a while physical server 406a resides at physical location 410a. The physical security devices 408a include hierarchies of locking mechanisms attached to series of access points that intersect physical pathways through the data center 402 that lead to the physical location 410a of the physical server 406a. Pursuant to the physical security policy for the compute instance 404, the first physical security action reconfigures these locking mechanisms, so only authorized personnel will be able to fully traverse the physical pathways leading to the physical location 410a of the physical server 406a. Furthermore, the physical security devices 408a include alarm mechanisms and/or surveillance mechanisms that can monitor the physical state of the physical server 406a, the physical location 410a of the physical server 406a, and/or the physical pathways leading to the physical location 410a of the physical server 406a. The first physical security action reconfigures these alarm mechanisms and/or surveillance mechanisms to monitor the physical server 406a in accordance with the physical security policy for the compute instance 404.

In an example embodiment, security orchestration platform 414 detects a migration of the compute instance 404 from the physical server 406a, and security orchestration platform 414 identifies a new physical server 406b that the compute instance 404 has migrated to (Operation 405). In addition to identifying the physical server 406b, the security orchestration platform 414 determines the physical location 410b of the physical server 406b within the data center 402, and the security orchestration platform 414 may reverse the first physical security action that was previously applied to physical security devices 408a.

In an example embodiment, security orchestration platform 414 maps the physical server 406b to physical security devices 408b, and security orchestration platform 414 applies a second physical security action to these physical security devices 408b to provide the appropriate level of protection to physical server 406b in accordance with the physical security policy for the compute instance 404 (Operation 407). Security orchestration platform 414 maps the physical server 406b to physical security devices 408b on the basis that these physical security devices 408b can provide some form of physical security to physical server 406b while physical server 406b resides at physical location 410b. The physical security devices 408b include hierarchies of locking mechanisms attached to series of access points that intersect physical pathways leading to the physical location 410b of the physical server 406b. Pursuant to the physical security policy for the compute instance 404, the second physical security action reconfigures these locking mechanisms, so only authorized personnel will be able to fully traverse these physical pathways leading to the physical location 410b of the physical server 406b. Furthermore, the physical security devices 408b include alarm mechanisms and/or surveillance mechanisms that can monitor the physical state of the physical server 406b, the physical location 410b of the physical server 406b, and the physical pathways leading to the physical location 410b of the physical server 406b. The second physical security action reconfigures these alarm mechanisms and/or surveillance mechanisms devices to monitor the physical server 406b in accordance with the physical security policy for the compute instance 404.

In an example embodiment, security orchestration platform 414 detects that physical server 406b has been relocated from physical location 410b to physical location 410c (Operation 409). Security orchestration platform 414 detects that physical server 406b has been relocated based on a termination and restart of compute instance 404 on physical server 406b accompanied by a change to a location associated with physical server 406b and/or a rack of servers that includes physical server 406b. For instance, security orchestration platform 414 may track coordinate positions of cloud infrastructure components, such as rolling racks of servers and/or individual physical servers 406, within data center 402. Accordingly, security orchestration platform 414 may discern that physical server 406b has been relocated based on a change to a coordinate position of physical server 406b and/or a coordinate position of a rolling rack of servers that includes physical server 406b. Additionally, or alternatively, for any given physical server 406 within data center 402, security orchestration platform 414 may track a rack of servers that the given physical server 406 is included in, a row of racks that this rack of servers belongs to, and/or the elevation of the given physical server 406 within this rack of servers. Thus, security orchestration platform 414 may detect that the physical server 406b has been relocated based on detecting a change to the row, rack, and/or elevation of physical server 406b.

In an example embodiment, security orchestration platform 414 remaps physical server 406b to physical security devices 408c, and security orchestration platform 414 applies a third physical security action to these physical security devices 408c to provide the appropriate level of protection to physical server 406b in accordance with the physical security policy for compute instance 404 (Operation 411). Security orchestration platform 414 remaps physical server 406b from physical security devices 408b to physical security devices 408c on the basis that physical security devices 408c can provide some form of physical security to physical server 406b while physical server 406b resides at the new physical location 410c. The physical security devices 408c include hierarchies of locking mechanisms attached to series of access points that intersect physical pathways leading to the new physical location 410c of the physical server 406b. Pursuant to the physical security policy for the compute instance 404, the third physical security action reconfigures these locking mechanisms, so only authorized personnel will be able to fully traverse these physical pathways leading to the new physical location 410c of the physical server 406b. Furthermore, the physical security devices 408c include alarm mechanisms and/or surveillance mechanisms that can monitor the physical state of the physical server 406b, the physical location 410c of the physical server 406b, and the physical pathways leading to the new physical location 410c of physical server 406b. The third physical security action reconfigures these alarm mechanisms and/or surveillance mechanisms devices to monitor the physical server 406b in accordance with the physical security policy for compute instance 404.

In an example embodiment, security orchestration platform 414 identifies an anomaly associated with physical server 406b that has been detected by a physical security device 408c, and security orchestration platform 414 applies a fourth physical security action to physical security devices 408c in response to the anomaly (Operation 413). For instance, physical security devices 408c may include a baseboard management controller included in physical server 406b, and the baseboard management controller may report an increase in temperature, increase in power consumption, a loss of power, or some other abnormal condition. In response to the anomaly, the fourth physical security action reconfigures physical security devices 408c to investigate the anomaly. For instance, physical security devices 408c may include surveillance mechanisms, such as a CCTV camera, that can be orientated to view the new physical location 410c of physical server 406b, and the fourth physical security action may reorient these surveillance mechanisms to observe the physical server 406b. Additionally, or alternatively, the third physical security action may have previously reconfigured these surveillance mechanisms to observe the physical server 406b, and the fourth physical security action may access the recordings of these surveillance mechanisms and analyze these recording to determine if any activity that may be associated with the anomaly can be identified.

In an example embodiment, security orchestration platform 414 alerts a cloud service consumer 416 associated with the compute instance 404 to the anomaly associated with the physical server 406b, and security orchestration platform 414 receives a repair order from the cloud service consumer 416 to correct the anomaly (Operation 415). In communicating with the cloud service consumer 416, the security orchestration platform 414 may supply the cloud Pa 44 service consumer 416 with recordings and/or analysis that were obtained by the security orchestration platform 414 while identifying and/or diagnosing the anomaly.

In an example embodiment, security orchestration platform 414 submits the repair order from the cloud service consumer 416 to a CSP 418 associated with the compute instance 404, and the security orchestration platform 414 receives an acceptance of the repair order from the CSP 418 (Operation 417). In communicating with the CSP 418, the security orchestration platform 414 may supply the cloud service consumer 418 with recordings and/or analysis that were obtained by the security orchestration platform 414 while identifying and/or diagnosing the anomaly.

In an example embodiment, security orchestration platform 414 applies a fifth physical security action to physical security devices 408c to provide CSP 418 personnel with physical access to physical server 406b (Operation 419). The security orchestration platform 414 selects a physical pathway through data center 402 leading to the new physical location 410c of physical server 406b that CSP 418 should be permitted to traverse to gain physical access to physical server 406b. The fifth physical security action reconfigures a hierarchy of locking mechanisms attached to a series of access points intersecting this physical pathway, so the CSP 418 personnel may pass through these access points. In addition, the fifth physical security action may reconfigure alarm mechanisms, so the personnel of the CSP 418 will not trip an alarm while attempting to physically access physical server 406b. Furthermore, the fifth physical security action may reconfigure surveillance mechanisms, so the cloud service consumer 416 and/or a cloud service operator of the data center 402 will be able to monitor the activity of the CSP 418 personnel while inside the data center 402.

In an example embodiment, security orchestration platform 414 instructs the CSP 418 on how to physically access physical server 406b (Operation 421). For instance, security orchestration platform 414 may provide CSP 418 with verbal instructions for physically accessing physical server 406b, credentials for traversing the physical pathway to the new physical location 410c of physical server 406b, a map of the physical pathway to the new physical location 410c of physical server 406b, and/or other information.

### 7. Examples of Cloud Infrastructure

As noted above, infrastructure as a service (i.e., IaaS) is one particular type of cloud computing. For IaaS, the infrastructure (i.e., CSPI) provided by a CSP can be configured to provide virtualized computing resources over a public network (e.g., the Internet). In an IaaS model, a CSP can host the infrastructure components (e.g., servers, storage devices, network nodes (e.g., hardware), deployment software, platform virtualization (e.g., a hypervisor layer), or the like). CSPI thus provides infrastructure and a set of complementary cloud services that enable customers to build and run a wide range of applications and services in a highly available hosted distributed environment. The customer does not manage or control the underlying physical resources provided by CSPI but has control over operating systems, storage, and deployed applications; and possibly limited control of select networking components (e.g., firewalls).

In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance. When a customer subscribes to or registers for an IaaS service provided by a CSP, a tenancy, or account, is created for the customer. A tenancy is a secure and isolated partition within the CSPI where the customer can create, organize, and administer their cloud resources.

In some instances, IaaS customers may access resources and services through a wide area network (WAN), such as the Internet, and can use the CSP's services to install the remaining elements of an application stack. For example, the user can log in to the IaaS platform to create VMs, install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

The CSP may provide a console that enables customers and network administrators to configure, access, and manage resources deployed in the cloud using CSPI resources. In certain embodiments, the console provides a web-based user interface that can be used to access and manage CSPI. In some implementations, the console is a web-based application provided by the CSP.

CSPI may support single-tenancy or multi-tenancy architectures. In a single tenancy architecture, a software (e.g., an application, a database) or a hardware component (e.g., a host machine or a server) of the CSPI serves a single customer or tenant. In a multi-tenancy architecture, a software or a hardware component of the CSPI serves multiple customers or tenants. Thus, in a multi-tenancy architecture, CSPI resources are shared between multiple customers or tenants. In a multi-tenancy situation, precautions are taken, and safeguards put in place within CSPI to ensure that each tenant's data is isolated and remains invisible to other tenants.

In certain embodiments, each resource within CSPI is assigned a unique identifier called a Cloud Identifier (CID). This identifier is included as part of the resource's information and can be used to manage the resource, for example, via a Console or through APIs. An example syntax for a CID is:
cid1.<RESOURCE TYPE>.<REALM>.[REGION][.FUTURE USE].<UNIQUE ID>
where,
cid1: The literal string indicating the version of the CID;
resource type: The type of resource (for example, instance, volume, VCN, subnet, user, group, and so on);
realm: The realm the resource is in. Example values are “c1” for the commercial realm, “c2” for the Government Cloud realm, or “c3” for the Federal Government Cloud realm, etc. Each realm may have its own domain name;
region: The region the resource is in. If the region is not applicable to the resource, this part might be blank;
future use: Reserved for future use.
unique ID: The unique portion of the ID. The format may vary depending on the type of resource or service.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service VMs (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more VMs. Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed are required to be set up first. In some instances, the provisioning can be done manually, a provisioning tool may be utilized to provision the resources, and/or deployment tools may be utilized to deploy the code once the infrastructure is provisioned.

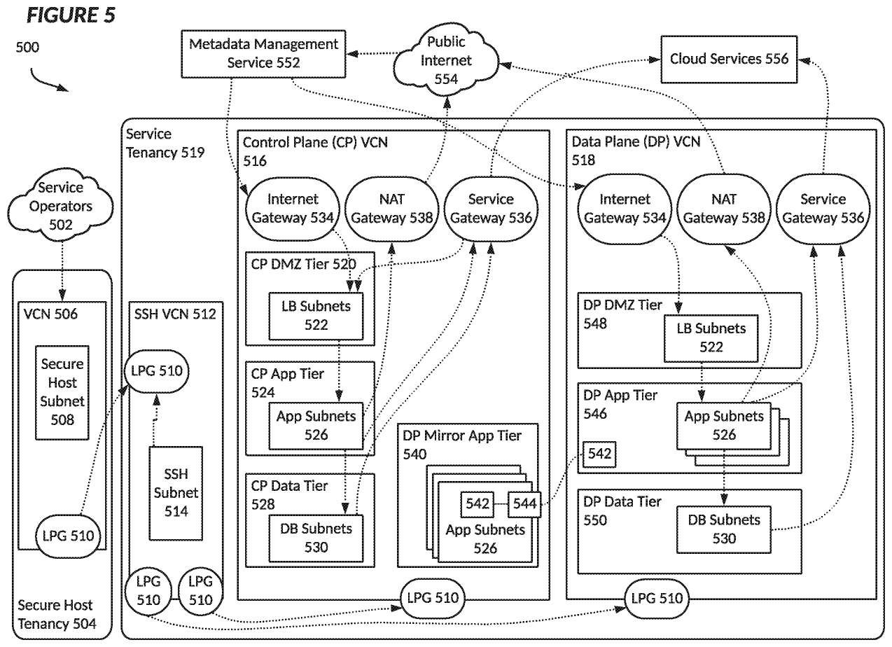

FIG. 5 is a block diagram 500 illustrating an example pattern of an IaaS architecture, according to at least one embodiment. Service operators 502 can be communicatively coupled to a secure host tenancy 504 that can include a VCN 506 and a secure host subnet 508. In some examples, the service operators 502 may be using one or more client computing devices, that may be portable handheld devices (e.g., an iPhone®, cellular telephone, an iPad®, computing tablet, a personal digital assistant (PDA)) or wearable devices (e.g., a Google Glass® head mounted display), executing software, such as Microsoft Windows Mobile®, and/or a variety of mobile operating systems, such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers, by way of example, including personal computers and/or laptop computers that are executing various versions of Microsoft Windows®, Apple Macintosh®, and/or Linux operating systems. The client computing devices can be workstation computers executing any of a variety of commercially available UNIX® or UNIX-like operating systems that include, for example, GNU/Linux operating systems and Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 506 and/or the Internet.

The VCN 506 can include a local peering gateway (LPG) 510 that can be communicatively coupled to a secure shell (SSH) VCN 512 via an LPG 510 implemented in the SSH VCN 512. The SSH VCN 512 can include an SSH subnet 514, and the SSH VCN 512 can be communicatively coupled to a control plane VCN 516 via the LPG 510 implemented in the control plane VCN 516. Also, the SSH VCN 512 can be communicatively coupled to a data plane VCN 518 via an LPG 510. The control plane VCN 516 and the data plane VCN 518 can be implemented in a service tenancy 519 that can be owned and/or operated by the IaaS provider.

The control plane VCN 516 can include a control plane demilitarized zone (DMZ) tier 520 that acts as a perimeter network (e.g., portions of a corporate network between the corporate intranet and external networks). The DMZ-based servers may have restricted responsibilities and help keep breaches contained. Additionally, the DMZ tier 520 can include one or more load balancer (LB) subnet(s) 522, a control plane app tier 524 that can include app subnet(s) 526, a control plane data tier 528 that can include database (DB) subnet(s) 530 (e.g., frontend DB subnet(s) and/or backend DB subnet(s)). The LB subnet(s) 522 in the control plane DMZ tier 520 can be communicatively coupled to the app subnet(s) 526 in the control plane app tier 524 and an Internet gateway 534 that can be implemented in the control plane VCN 516. The app subnet(s) 526 can be communicatively coupled to the DB subnet(s) 530 implemented in the control plane data tier 528 and a service gateway 536 and a network address translation (NAT) gateway 538. The control plane VCN 516 can include the service gateway 536 and the NAT gateway 538.

The control plane VCN 516 can include a data plane mirror app tier 540 that can include app subnet(s) 526. The app subnet(s) 526 implemented in the data plane mirror app tier 540 can include a virtual network interface controller (VNIC) 542 that can execute a compute instance 544. The compute instance 544 can communicatively couple the app subnet(s) 526 of the data plane mirror app tier 540 to app subnet(s) 526 that can be implemented in a data plane app tier 546.

The data plane VCN 518 can include the data plane app tier 546, a data plane DMZ tier 548, and a data plane data tier 550. The data plane DMZ tier 548 can include LB subnet(s) 522 that can be communicatively coupled to the app subnet(s) 526 of the data plane app tier 546 and the Internet gateway 534 of the data plane VCN 518. The app subnet(s) 526 can be communicatively coupled to the service gateway 536 of the data plane VCN 518 and the NAT gateway 538 of the data plane VCN 518. The data plane data tier 550 can also include the DB subnet(s) 530 that can be communicatively coupled to the app subnet(s) 526 of the data plane app tier 546.

The Internet gateway 534 of the control plane VCN 516 and of the data plane VCN 518 can be communicatively coupled to a metadata management service 552 that can be communicatively coupled to public Internet 554. Public Internet 554 can be communicatively coupled to the NAT gateway 538 of the control plane VCN 516 and of the data plane VCN 518. The service gateway 536 of the control plane VCN 516 and of the data plane VCN 518 can be communicatively couple to cloud services 556.

In some examples, the service gateway 536 of the control plane VCN 516 or of the data plane VCN 518 can make application programming interface (API) calls to cloud services 556 without going through public Internet 554. The API calls to cloud services 556 from the service gateway 536 can be one-way; the service gateway 536 can make API calls to cloud services 556, and cloud services 556 can send requested data to the service gateway 536. However, cloud services 556 may not initiate API calls to the service gateway 536.

In some examples, the secure host tenancy 504 can be directly connected to the service tenancy 519. The service tenancy 519 may otherwise be isolated. The secure host subnet 508 can communicate with the SSH subnet 514 through an LPG 510 that may enable two-way communication over an otherwise isolated system. Connecting the secure host subnet 508 to the SSH subnet 514 may give the secure host subnet 508 access to other entities within the service tenancy 519.

The control plane VCN 516 may allow users of the service tenancy 519 to set up or otherwise provision resources. Resources provisioned in the control plane VCN 516 may be deployed or otherwise used in the data plane VCN 518. In some examples, the control plane VCN 516 can be isolated from the data plane VCN 518, and the data plane mirror app tier 540 of the control plane VCN 516 can communicate with the data plane app tier 546 of the data plane VCN 518 via VNICs 542 that can be implemented in the data plane mirror app tier 540 and the data plane app tier 546.

In some examples, users or customers, of the system, can make requests, for example create, read, update, or delete (CRUD) operations, through public Internet 554 that can communicate the requests to the metadata management service 552. The metadata management service 552 can communicate the request to the control plane VCN 516 through the Internet gateway 534. The request can be received by the LB subnet(s) 522 implemented in the control plane DMZ tier 520. The LB subnet(s) 522 may determine that the request is valid, and in response, the LB subnet(s) 522 can transmit the request to app subnet(s) 526 implemented in the control plane app tier 524. If the request is validated and requires a call to public Internet 554, the call to public Internet 554 may be transmitted to the NAT gateway 538 that can make the call to public Internet 554. Metadata to be stored by the request can be stored in the DB subnet(s) 530.

In some examples, the data plane mirror app tier 540 can facilitate direct communication between the control plane VCN 516 and the data plane VCN 518. For example, changes, updates, or other suitable modifications to a configuration may need to be applied to the resources implemented in the data plane VCN 518. Via a VNIC 542, the control plane VCN 516 can directly communicate with, and can thereby execute the changes, updates, or other suitable modifications to configuration to, resources implemented in the data plane VCN 518.

In some embodiments, the control plane VCN 516 and the data plane VCN 518 can be implemented in the service tenancy 519. In this case, the user, or the customer, of the system may not own or operate either the control plane VCN 516 or the data plane VCN 518. Instead, the IaaS provider may own or operate the control plane VCN 516 and the data plane VCN 518. The control plane VCN 516 and the data plane VCN 518 may be implemented in the service tenancy 519. This embodiment can enable isolation of networks that may prevent users or customers from interacting with other users', or other customers', resources. Also, this embodiment may allow users, or customers, of the system to store databases privately without needing to rely on public Internet 554, that may not have a sufficient level of threat protection, for storage.

In other embodiments, the LB subnet(s) 522 implemented in the control plane VCN 516 can be configured to receive a signal from the service gateway 536. In this embodiment, the control plane VCN 516 and the data plane VCN 518 may be configured to be called by a customer of the IaaS provider without calling public Internet 554. Customers of the IaaS provider may need this embodiment since database(s) that the customers use may be controlled by the IaaS provider and may be stored on the service tenancy 519. The service tenancy 519 may be isolated from public Internet 554.

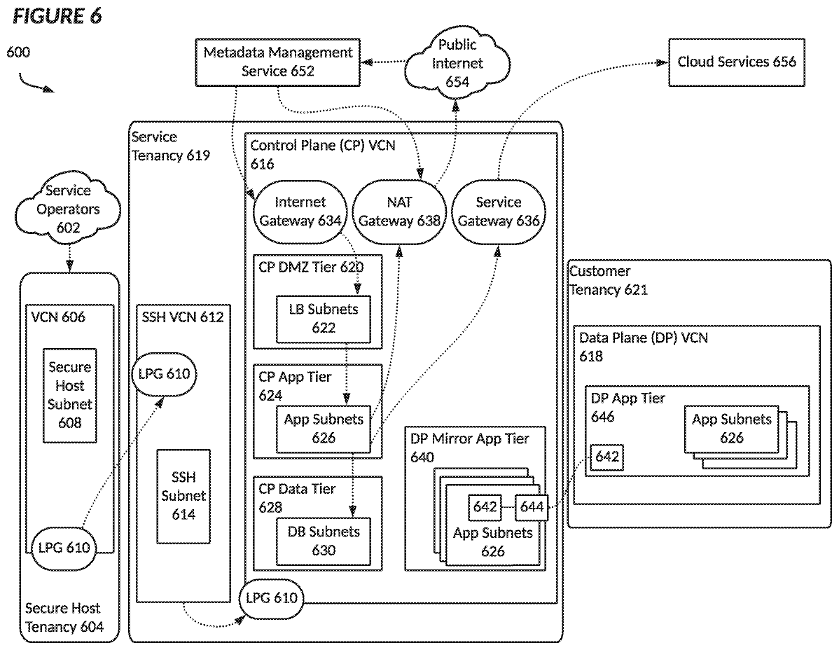

FIG. 6 is a block diagram 600 illustrating another example pattern of an IaaS architecture, according to at least one embodiment. Service operators 602 (e.g., service operators 502 of FIG. 5) can be communicatively coupled to a secure host tenancy 604 (e.g., the secure host tenancy 504 of FIG. 5) that can include a VCN 606 (e.g., the VCN 506 of FIG. 5) and a secure host subnet 608 (e.g., the secure host subnet 508 of FIG. 5). The VCN 606 can include a local peering gateway (LPG) 610 (e.g., the LPG 510 of FIG. 5) that can be communicatively coupled to a secure shell (SSH) VCN 612 (e.g., the SSH VCN 512 of FIG. 5) via an LPG 610 implemented in the SSH VCN 612. The SSH VCN 612 can include an SSH subnet 614 (e.g., the SSH subnet 514 of FIG. 5), and the SSH VCN 612 can be communicatively coupled to a control plane VCN 616 (e.g., the control plane VCN 516 of FIG. 5) via an LPG 610 implemented in the control plane VCN 616. The control plane VCN 616 can be implemented in a service tenancy 619 (e.g., the service tenancy 519 of FIG. 5), and the data plane VCN 618 (e.g., the data plane VCN 518 of FIG. 5) can be implemented in a customer tenancy 621 that may be owned or operated by users, or customers, of the system.

The control plane VCN 616 can include a control plane DMZ tier 620 (e.g., the control plane DMZ tier 520 of FIG. 5) that can include LB subnet(s) 622 (e.g., LB subnet(s) 522 of FIG. 5), a control plane app tier 624 (e.g., the control plane app tier 524 of FIG. 5) that can include app subnet(s) 626 (e.g., app subnet(s) 526 of FIG. 5), and a control plane data tier 628 (e.g., the control plane data tier 528 of FIG. 5) that can include database (DB) subnet(s) 630 (e.g., similar to DB subnet(s) 530 of FIG. 5). The LB subnet(s) 622 implemented in the control plane DMZ tier 620 can be communicatively coupled to the app subnet(s) 626 implemented in the control plane app tier 624 and an Internet gateway 634 (e.g., the Internet gateway 534 of FIG. 5) that can be implemented in the control plane VCN 616. The app subnet(s) 626 can be communicatively coupled to the DB subnet(s) 630 implemented in the control plane data tier 628 and a service gateway 636 (e.g., the service gateway 536 of FIG. 5) and a network address translation (NAT) gateway 638 (e.g., the NAT gateway 538 of FIG. 5). The control plane VCN 616 can include the service gateway 636 and the NAT gateway 638.

The control plane VCN 616 can include a data plane mirror app tier 640 (e.g., the data plane mirror app tier 540 of FIG. 5) that can include app subnet(s) 626. The app subnet(s) 626 implemented in the data plane mirror app tier 640 can include a virtual network interface controller (VNIC) 642 (e.g., the VNIC of 542) that can execute a compute instance 644 (e.g., similar to the compute instance 544 of FIG. 5). The compute instance 644 can facilitate communication between the app subnet(s) 626 of the data plane mirror app tier 640 and the app subnet(s) 626 that can be implemented in a data plane app tier 646 (e.g., the data plane app tier 546 of FIG. 5). The compute instance 644 can facilitate this communication via the VNIC 642 implemented in the data plane mirror app tier 640 and the VNIC 642 implemented in the data plane app tier 646.

The Internet gateway 634 implemented in the control plane VCN 616 can be communicatively coupled to a metadata management service 652 (e.g., the metadata management service 552 of FIG. 5) that can be communicatively coupled to public Internet 654 (e.g., public Internet 554 of FIG. 5). Public Internet 654 can be communicatively coupled to the NAT gateway 638 implemented in the control plane VCN 616. The service gateway 636 implemented in the control plane VCN 616 can be communicatively couple to cloud services 656 (e.g., cloud services 556 of FIG. 5).

In some examples, the data plane VCN 618 can be implemented in the customer tenancy 621. In this case, the IaaS provider may provide the control plane VCN 616 for a customer, and the IaaS provider may, for a customer, set up a unique, compute instance 644 that is implemented in the service tenancy 619. A compute instance 644 may allow communication between the control plane VCN 616 implemented in the service tenancy 619 and the data plane VCN 618 that is implemented in the customer tenancy 621. The compute instance 644 may allow resources provisioned in the control plane VCN 616 that is implemented in the service tenancy 619 to be deployed or otherwise used in the data plane VCN 618 that is implemented in the customer tenancy 621.

In other examples, the customer of the IaaS provider may have databases that are implemented in the customer tenancy 621. In this example, the control plane VCN 616 can include the data plane mirror app tier 640 that can include app subnet(s) 626. The data plane mirror app tier 640 can be implemented in the control plane VCN 616, but the data plane mirror app tier 640 may not be implemented in the data plane VCN 618. That is, the data plane mirror app tier 640 may have access to the customer tenancy 621, but the data plane mirror app tier 640 may not exist in the data plane VCN 618 or be owned or operated by the customer of the IaaS provider. The data plane mirror app tier 640 may be configured to make calls to the data plane VCN 618 but may not be configured to make calls to any entity implemented in the control plane VCN 616. The customer may need to deploy or otherwise use resources in the data plane VCN 618 that are provisioned in the control plane VCN 616, and the data plane mirror app tier 640 can facilitate the deployment or other usage of resources of the customer.

In some embodiments, the customer of the IaaS provider can apply filters to the data plane VCN 618. In this embodiment, the customer can determine what the data plane VCN 618 can access, and the customer may restrict access to public Internet 654 from the data plane VCN 618. The IaaS provider may not be able to apply filters or otherwise control access of the data plane VCN 618 to any outside networks or databases. Applying filters and controls by the customer onto the data plane VCN 618, implemented in the customer tenancy 621, can help isolate the data plane VCN 618 from other customers and from public Internet 654.

In some embodiments, cloud services 656 can be called by the service gateway 636 to access services that may not exist on public Internet 654, on the control plane VCN 616, or on the data plane VCN 618. The connection between cloud services 656 and the control plane VCN 616 or the data plane VCN 618 may not be active or continuous. Cloud services 656 may exist on a different network owned or operated by the IaaS provider. Cloud services 656 may be configured to receive calls from the service gateway 636 and may be configured to not receive calls from public Internet 654. Some cloud services 656 may be isolated from other cloud services 656, and the control plane VCN 616 may be isolated from cloud services 656 that may not be in the same region as the control plane VCN 616. For example, the control plane VCN 616 may be located in “Region 1,” and cloud service “Deployment 1” may be located in Region 1 and in “Region 2.” If a call to Deployment 1 is made by the service gateway 636 implemented in the control plane VCN 616 located in Region 1, the call may be transmitted to Deployment 1 in Region 1. In this example, the control plane VCN 616, or Deployment 1 in Region 1, may not be communicatively coupled to, or otherwise in communication with, Deployment 1 in Region 2.

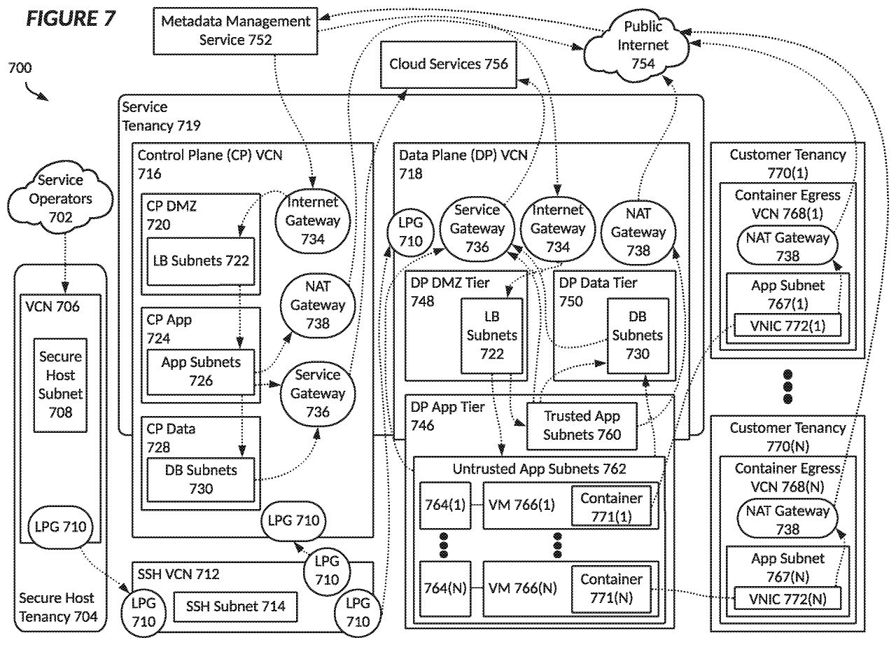

FIG. 7 is a block diagram 300 illustrating another example pattern of an IaaS architecture, according to at least one embodiment. Service operators 702 (e.g., service operators 502 of FIG. 5) can be communicatively coupled to a secure host tenancy 704 (e.g., the secure host tenancy 504 of FIG. 5) that can include a VCN 706 (e.g., the VCN 506 of FIG. 5) and a secure host subnet 708 (e.g., the secure host subnet 508 of FIG. 5). The VCN 706 can include an LPG 710 (e.g., the LPG 510 of FIG. 5) that can be communicatively coupled to an SSH VCN 712 (e.g., the SSH VCN 512 of FIG. 5) via an LPG 710 implemented in the SSH VCN 712. The SSH VCN 712 can include an SSH subnet 714 (e.g., the SSH subnet 514 of FIG. 5), and the SSH VCN 712 can be communicatively coupled to a control plane VCN 716 (e.g., the control plane VCN 516 of FIG. 5) via an LPG 710 implemented in the control plane VCN 716 and to a data plane VCN 718 (e.g., the data plane VCN 518 of FIG. 5) via an LPG 710 implemented in the data plane VCN 718. The control plane VCN 716 and the data plane VCN 718 can be implemented in a service tenancy 719 (e.g., the service tenancy 519 of FIG. 5).

The control plane VCN 716 can include a control plane DMZ tier 720 (e.g., the control plane DMZ tier 520 of FIG. 5) that can include load balancer (LB) subnet(s) 722 (e.g., LB subnet(s) 522 of FIG. 5), a control plane app tier 724 (e.g., the control plane app tier 524 of FIG. 5) that can include app subnet(s) 726 (e.g., similar to app subnet(s) 526 of FIG. 5), and a control plane data tier 728 (e.g., the control plane data tier 528 of FIG. 5) that can include DB subnet(s) 730. The LB subnet(s) 722 implemented in the control plane DMZ tier 720 can be communicatively coupled to the app subnet(s) 726 implemented in the control plane app tier 724 and to an Internet gateway 734 (e.g., the Internet gateway 534 of FIG. 5) that can be implemented in the control plane VCN 716, and the app subnet(s) 726 can be communicatively coupled to the DB subnet(s) 730 implemented in the control plane data tier 728 and to a service gateway 736 (e.g., the service gateway of FIG. 5) and a network address translation (NAT) gateway 738 (e.g., the NAT gateway 538 of FIG. 5). The control plane VCN 716 can include the service gateway 736 and the NAT gateway 738.

The data plane VCN 718 can include a data plane app tier 746 (e.g., the data plane app tier 546 of FIG. 5), a data plane DMZ tier 748 (e.g., the data plane DMZ tier 548 of FIG. 5), and a data plane data tier 750 (e.g., the data plane data tier 550 of FIG. 5). The data plane DMZ tier 748 can include LB subnet(s) 722 that can be communicatively coupled to trusted app subnet(s) 760, untrusted app subnet(s) 762 of the data plane app tier 746, and the Internet gateway 734 implemented in the data plane VCN 718. The trusted app subnet(s) 760 can be communicatively coupled to the service gateway 736 implemented in the data plane VCN 718, the NAT gateway 738 implemented in the data plane VCN 718, and DB subnet(s) 730 implemented in the data plane data tier 750. The untrusted app subnet(s) 762 can be communicatively coupled to the service gateway 736 implemented in the data plane VCN 718 and DB subnet(s) 730 implemented in the data plane data tier 750. The data plane data tier 750 can include DB subnet(s) 730 that can be communicatively coupled to the service gateway 736 implemented in the data plane VCN 718.

The untrusted app subnet(s) 762 can include one or more primary VNICs 764(1)-(N) that can be communicatively coupled to tenant VMs 766(1)-(N). Tenant VMs 766(1)-(N) can be communicatively coupled to a respective app subnets 767(1)-(N) that can be implemented in respective container egress VCNs 768(1)-(N) that can be implemented in respective customer tenancies 770(1)-(N). Respective secondary VNICs 772(1)-(N) can facilitate communication between the untrusted app subnet(s) 762 implemented in the data plane VCN 718 and the app subnet implemented in the container egress VCNs 768(1)-(N). Container egress VCNs 768(1)-(N) can include a NAT gateway 738 that can be communicatively coupled to public Internet 754 (e.g., public Internet 554 of FIG. 5).

The Internet gateway 734 implemented in the control plane VCN 716 and implemented in the data plane VCN 718 can be communicatively coupled to a metadata management service 752 (e.g., the metadata management service 552 of FIG. 5) that can be communicatively coupled to public Internet 754. Public Internet 754 can be communicatively coupled to the NAT gateway 738 implemented in the control plane VCN 716 and implemented in the data plane VCN 718. The service gateway 736 implemented in the control plane VCN 716 and implemented in the data plane VCN 718 can be communicatively couple to cloud services 756.

In some embodiments, the data plane VCN 718 can be integrated with customer tenancies 770(1)-(N). This integration can be useful or needed for customers of the IaaS provider in some cases such as a case that may need support when executing code. The customer may provide code to execute that may be destructive, may communicate with other customer resources, or may otherwise cause undesirable effects. In response to this, the IaaS provider may determine whether or not to execute code given to the IaaS provider by the customer.

In some examples, the customer of the IaaS provider may grant temporary network access to the IaaS provider and request a function to be attached to the data plane app tier 746. Code to execute the function may be executed in the VMs 766(1)-(N), and the code may not be configured to execute anywhere else on the data plane VCN 718. VMs 766(1)-(N) may be connected to one customer tenancy 770(1). Respective containers 771(1)-(N) implemented in the VMs 766(1)-(N) may be configured to execute the code. In this case, there can be a dual isolation (e.g., the containers 771(1)-(N) executing code), where the containers 771(1)-(N) may be implemented in at least the VM 766(1)-(N) that are implemented in the untrusted app subnet(s) 762) that may help prevent incorrect or otherwise undesirable code from damaging the network of the IaaS provider or from damaging a network of a different customer. The containers 771(1)-(N) may be communicatively coupled to the customer tenancy 770 and may be configured to transmit or receive data from the customer tenancy 770. The containers 771(1)-(N) may not be configured to transmit or receive data from any other entity in the data plane VCN 718. Upon completing execution of the code, the IaaS provider may terminate or otherwise dispose of the containers 771(1)-(N).

In some embodiments, the trusted app subnet(s) 760 may execute code that may be owned or operated by the IaaS provider. In this embodiment, the trusted app subnet(s) 760 may be communicatively coupled to the DB subnet(s) 730 and be configured to execute CRUD operations in the DB subnet(s) 730. The untrusted app subnet(s) 762 may be communicatively coupled to the DB subnet(s) 730, but in this embodiment, the untrusted app subnet(s) may be configured to execute read operations in the DB subnet(s) 730. The containers 771(1)-(N) that can be implemented in the VM 766(1)-(N) of a customer and that may execute code from the customer may not be communicatively coupled with the DB subnet(s) 730.

In other embodiments, the control plane VCN 716 and the data plane VCN 718 may not be directly communicatively coupled. In this embodiment, there may be no direct communication between the control plane VCN 716 and the data plane VCN 718. However, communication can occur indirectly through at least one method. An LPG 710 may be established by the IaaS provider that can facilitate communication between the control plane VCN 716 and the data plane VCN 718. In another example, the control plane VCN 716 or the data plane VCN 718 can make a call to cloud services 756 via the service gateway 736. For example, a call to cloud services 756 from the control plane VCN 716 can include a request for a service that can communicate with the data plane VCN 718.

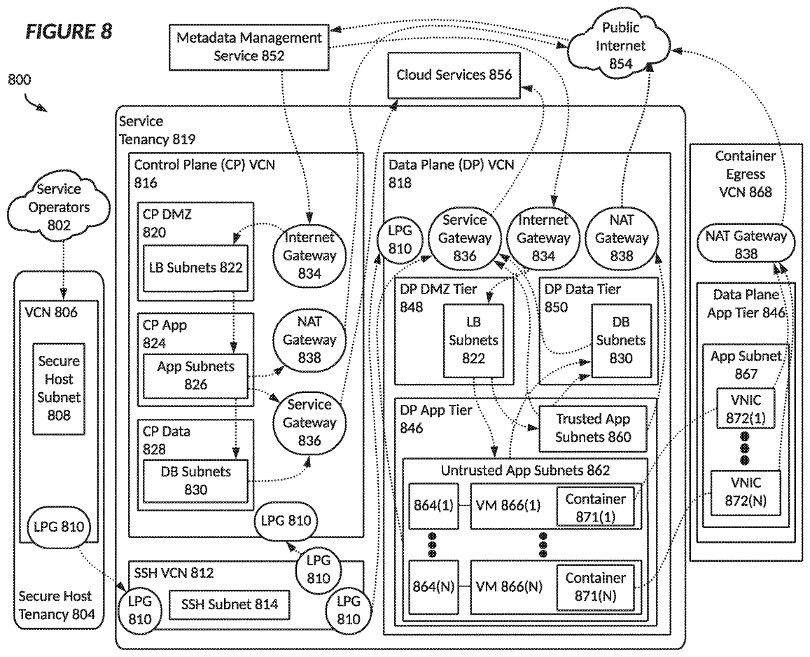

FIG. 8 is a block diagram illustrating another example pattern of an IaaS architecture 800 according to at least one embodiment. Service operators 802 (e.g., service operators 502 of FIG. 5) can be communicatively coupled to a secure host tenancy 804 (e.g., the secure host tenancy 504 of FIG. 5) that can include a VCN 806 (e.g., the VCN 506 of FIG. 5) and a secure host subnet 808 (e.g., the secure host subnet 508 of FIG. 5). The VCN 806 can include an LPG 810 (e.g., the LPG 510 of FIG. 5) that can be communicatively coupled to an SSH VCN 812 (e.g., the SSH VCN 512 of FIG. 5) via an LPG 810 implemented in the SSH VCN 812. The SSH VCN 812 can include an SSH subnet 814 (e.g., the SSH subnet 514 of FIG. 5), and the SSH VCN 812 can be communicatively coupled to a control plane VCN 816 (e.g., the control plane VCN 516 of FIG. 5) via an LPG 810 implemented in the control plane VCN 816 and to a data plane VCN 818 (e.g., the data plane VCN 518 of FIG. 5) via an LPG 810 implemented in the data plane VCN 818. The control plane VCN 816 and the data plane VCN 818 can be implemented in a service tenancy 819 (e.g., the service tenancy 519 of FIG. 5).

The control plane VCN 816 can include a control plane DMZ tier 820 (e.g., the control plane DMZ tier 520 of FIG. 5) that can include LB subnet(s) 822 (e.g., LB subnet(s) 522 of FIG. 5), a control plane app tier 824 (e.g., the control plane app tier 524 of FIG. 5) that can include app subnet(s) 826 (e.g., app subnet(s) 526 of FIG. 5), and a control plane data tier 828 (e.g., the control plane data tier 528 of FIG. 5) that can include DB subnet(s) 830 (e.g., DB subnet(s) 730 of FIG. 7). The LB subnet(s) 822 implemented in the control plane DMZ tier 820 can be communicatively coupled to the app subnet(s) 826 implemented in the control plane app tier 824 and to an Internet gateway 834 (e.g., the Internet gateway 534 of FIG. 5) that can be implemented in the control plane VCN 816, and the app subnet(s) 826 can be communicatively coupled to the DB subnet(s) 830 implemented in the control plane data tier 828 and to a service gateway 836 (e.g., the service gateway of FIG. 5) and a network address translation (NAT) gateway 838 (e.g., the NAT gateway 538 of FIG. 5). The control plane VCN 816 can include the service gateway 836 and the NAT gateway 838.

The data plane VCN 818 can include a data plane app tier 846 (e.g., the data plane app tier 546 of FIG. 5), a data plane DMZ tier 848 (e.g., the data plane DMZ tier 548 of FIG. 5), and a data plane data tier 850 (e.g., the data plane data tier 550 of FIG. 5). The data plane DMZ tier 848 can include LB subnet(s) 822 that can be communicatively coupled to trusted app subnet(s) 860 (e.g., trusted app subnet(s) 760 of FIG. 7) and untrusted app subnet(s) 862 (e.g., untrusted app subnet(s) 762 of FIG. 7) of the data plane app tier 846 and the Internet gateway 834 implemented in the data plane VCN 818. The trusted app subnet(s) 860 can be communicatively coupled to the service gateway 836 implemented in the data plane VCN 818, the NAT gateway 838 implemented in the data plane VCN 818, and DB subnet(s) 830 implemented in the data plane data tier 850. The untrusted app subnet(s) 862 can be communicatively coupled to the service gateway 836 implemented in the data plane VCN 818 and DB subnet(s) 830 implemented in the data plane data tier 850. The data plane data tier 850 can include DB subnet(s) 830 that can be communicatively coupled to the service gateway 836 implemented in the data plane VCN 818.

The untrusted app subnet(s) 862 can include primary VNICs 864(1)-(N) that can be communicatively coupled to tenant VMs 866(1)-(N) implemented within the untrusted app subnet(s) 862. Tenant VMs 866(1)-(N) can execute code in a respective container 867(1)-(N) and be communicatively coupled to an app subnet 867 that can be implemented in a data plane app tier 846 that can be implemented in a container egress VCN 868. Respective secondary VNICs 872(1)-(N) can facilitate communication between the untrusted app subnet(s) 862 implemented in the data plane VCN 818 and the app subnet 867 implemented in the container egress VCN 868. The container egress VCN 868 can include a NAT gateway 838 that can be communicatively coupled to public Internet 854 (e.g., public Internet 554 of FIG. 5).

The Internet gateway 834 implemented in the control plane VCN 816 and implemented in the data plane VCN 818 can be communicatively coupled to a metadata management service 852 (e.g., the metadata management service 552 of FIG. 5) that can be communicatively coupled to public Internet 854. Public Internet 854 can be communicatively coupled to the NAT gateway 838 implemented in the control plane VCN 816 and implemented in the data plane VCN 818. The service gateway 836 implemented in the control plane VCN 816 and implemented in the data plane VCN 818 can be communicatively couple to cloud services 856.

In some examples, the pattern illustrated by the architecture of block diagram 800 of FIG. 8 may be considered an exception to the pattern illustrated by the architecture of block diagram 700 of FIG. 7 and may be needed for a customer of the IaaS provider if the IaaS provider cannot directly communicate with the customer (e.g., a disconnected region). The respective containers 871(1)-(N) that are implemented in the VMs 866(1)-(N) for a customer can be accessed in real-time by the customer. The containers 871(1)-(N) may be configured to make calls to respective secondary VNICs 872(1)-(N) implemented in app subnet(s) 867 of the data plane app tier 846 that can be implemented in the container egress VCN 868. The secondary VNICs 872(1)-(N) can transmit the calls to the NAT gateway 838 that may transmit the calls to public Internet 854. In this example, the containers 871(1)-(N) that can be accessed in real time by the customer can be isolated from the control plane VCN 816 and can be isolated from other entities implemented in the data plane VCN 818. The containers 871(1)-(N) may also be isolated from resources from other customers.

In other examples, the customer can use the containers 871(1)-(N) to call cloud services 856. In this example, the customer may execute code in the containers 871(1)-(N) that request a service from cloud services 856. The containers 871(1)-(N) can transmit this request to the secondary VNICs 872(1)-(N) that can transmit the request to the NAT gateway 838 that can transmit the request to public Internet 854. Public Internet 854 can transmit the request to LB subnet(s) 822 implemented in the control plane VCN 816 via the Internet gateway 834. In response to determining the request is valid, the LB subnet(s) can transmit the request to app subnet(s) 826 that can transmit the request to cloud services 856 via the service gateway 836.

It should be appreciated that IaaS architectures 500, 600, 700, and 800 may include components that are different and/or additional to the components shown in the figures. Furthermore, the embodiments shown in the figures represent non-exhaustive examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. A node may be local to and/or remote from another node. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various VMs and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network such as a physical network. A node in an overlay network corresponds to a respective node in the underlying network. Hence, a node in an overlay network may be associated with both an overlay address (for data to be addressed to the overlay node) and an underlay address (for data to be addressed to the underlay node that implements the overlay node). An overlay node may be a digital device and/or a software process, such as a VM, an application instance, or a thread. A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a VM, a container, and/or a software application. Network resources are shared amongst multiple clients. Clients request computing services from a computer network independently of other clients. Network resources are dynamically assigned to the requests and/or clients on an on-demand basis. Network resources assigned to a request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited to, Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources may be provisioned for an entity that is independent from other entities (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud may have dependencies on applications implemented at the public cloud and vice-versa. A call from an application at the private cloud to an application at the public cloud (and vice versa) may be executed through the interface.

In an embodiment, a tenant of a multi-tenant computer network is independent of another tenant of the same multi-tenant computer network. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared across tenants. Various tenant isolation approaches may be used.

In an embodiment, a tenant is associated with a tenant ID. A network resource of the multi-tenant computer network is tagged with a tenant ID. A tenant is permitted access to a particular network resource when the tenant and the particular network resources are associated with a same tenant ID.

In an embodiment, a tenant is associated with a tenant ID. An application, implemented by the computer network, is tagged with a tenant ID. Additionally, or alternatively, a data structure and/or dataset, stored by the computer network, is tagged with a tenant ID. A tenant is permitted access to a particular application, data structure, and/or dataset when the tenant and the particular application, data structure, and/or dataset are associated with a same tenant ID.

As an example, a database implemented by a multi-tenant computer network may be tagged with a tenant ID. A tenant associated with the corresponding tenant ID may access data of a particular database. As another example, an entry in a database implemented by a multi-tenant computer network may be tagged with a tenant ID. A tenant associated with the corresponding tenant ID may access data of a particular entry. However, multiple tenants may share the database.

In an embodiment, a subscription list identifies a set of tenants, and, for a tenant, a set of applications that the tenant is authorized to access. For an application, a list of tenant IDs of tenants authorized to access the application is stored. A tenant is permitted access to a particular application when the tenant ID of the tenant is implemented in the subscription list corresponding to the particular application.

In an embodiment, network resources (such as digital devices, VMs, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 8. Computer System

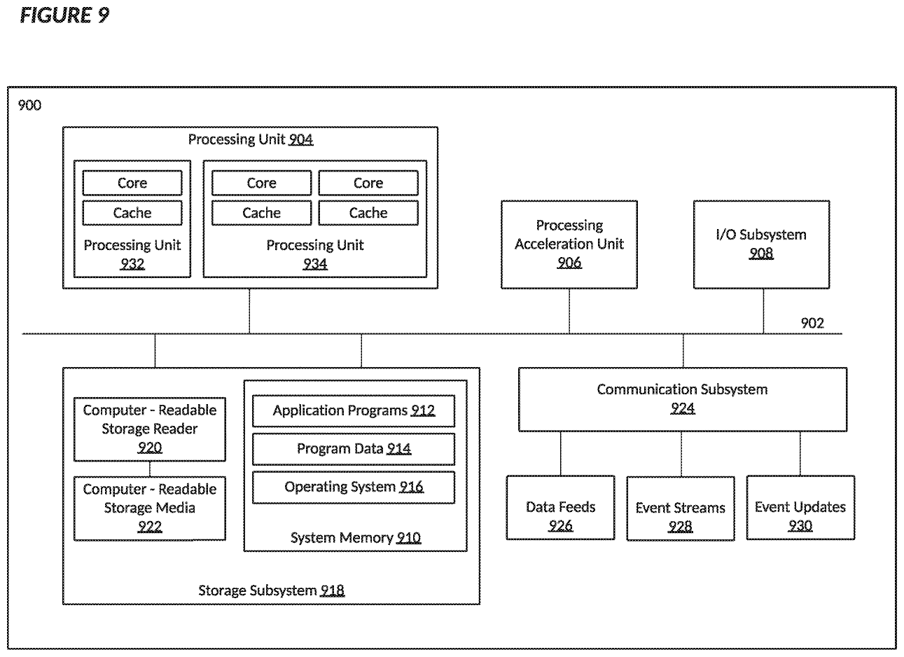

FIG. 9 illustrates an example computer system 900 in accordance with one or more embodiments. An embodiment of the disclosure may be implemented upon the computer system 900. As shown in FIG. 9, computer system 900 includes a processing unit 904 that communicates with peripheral subsystems via a bus subsystem 902. These peripheral subsystems may include a processing acceleration unit 906, an I/O subsystem 908, a storage subsystem 918, and a communications subsystem 924. Storage subsystem 918 includes tangible computer-readable storage media 922, computer-readable storage reader 920 and a system memory 910.

Bus subsystem 902 provides a mechanism for letting the various components and subsystems of computer system 900 to communicate with other components and subsystems as intended. Although bus subsystem 902 is shown schematically as a single bus, alternative embodiments of the bus subsystem may utilize multiple buses. Bus subsystem 902 may be any of several types of bus structures, including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Additionally, such architectures may be implemented as a Mezzanine bus manufactured to the Institute of Electrical and Electronics Engineers (IEEE) P1386.1 standard.

Processing unit 904 controls the operation of computer system 900. Processing unit 904 can be implemented as one or more integrated circuits (e.g., a conventional microprocessor or microcontroller). One or more processors may be implemented in processing unit 904. These processors may include single core or multicore processors. In certain embodiments, processing unit 904 may be implemented as one or more independent sub processing units 932 and/or 934 with single or multicore processors implemented in one or more processing units. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, the program code to be executed can be wholly or partially implemented in processing unit 904 and/or in storage subsystem 918. Through suitable programming, processing unit 904 can provide various functionalities described above. Computer system 900 may additionally include a processing acceleration unit 906 that can include a digital signal processor (DSP), a special-purpose processor, and/or the like.

I/O subsystem 908 may include user interface input devices and user interface output devices. User interface input devices may include a keyboard, pointing devices, such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices, such as the Microsoft Kinect® motion sensor that enables users to control and interact with an input device, such as the Microsoft Xbox® 360 game controller, through a natural user interface using gestures and spoken commands. User interface input devices may also include eye gesture recognition devices, such as the Google Glass® blink detector, that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices, such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include medical imaging input devices, such as computed tomography, magnetic resonance imaging, position emission tomography, or medical ultrasonography devices. User interface input devices may also include audio input devices, such as MIDI keyboards, digital musical instruments and the like.

User interface output devices may include a display subsystem, indicator lights, or non-visual displays, such as audio output devices. The display subsystem may be a cathode ray tube (CRT), a flat-panel device, such as that using a liquid crystal display (LCD) or plasma display, a projection device, a touch screen, and the like. In general, use of the term “output device” is intended to include any type of device and mechanism for outputting information from computer system 900 to a user or other computer. For example, user interface output devices may include, without limitation, a variety of display devices that visually convey text, graphics and audio/video information, such as monitors, printers, speakers, headphones, automotive navigation systems, plotters, voice output devices, and modems.

Computer system 900 may comprise a storage subsystem 918 that provides a tangible, non-transitory, computer-readable storage medium for storing software and data constructs that provide the functionality of the embodiments described in this disclosure. The software can include programs, code modules, instructions, scripts, etc., that, when executed by one or more cores or processors of processing unit 904, provide the functionality described above. Storage subsystem 918 may also provide a repository for storing data used in accordance with the present disclosure.

As depicted in the example in FIG. 9, storage subsystem 918 can include various components, including a system memory 910, computer-readable storage media 922, and a computer readable storage media reader 920. System memory 910 may store program instructions, such as application programs 912, that are loadable and executable by processing unit 904. System memory 910 may also store data, such as program data 914, that is used during the execution of the instructions and/or data that is generated during the execution of the program instructions. Various programs may be loaded into system memory 910 including, but not limited to, client applications, Web browsers, mid-tier applications, relational database management systems (RDBMS), VMs, containers, etc.

System memory 910 may also store an operating system 916. Examples of operating system 916 may include various versions of Microsoft Windows®, Apple Macintosh®, and/or Linux operating systems, a variety of commercially available UNIX® or UNIX-like operating systems (including without limitation the variety of GNU/Linux operating systems, the Google Chrome® OS, and the like) and/or mobile operating systems, such as iOS, Windows® Phone, Android® OS, BlackBerry® OS, and Palm® OS operating systems. In certain implementations where computer system 900 executes one or more VMs, the VMs, along with their guest operating systems (GOSs), may be loaded into system memory 910 and executed by one or more processors or cores of processing unit 904.

System memory 910 can come in different configurations depending upon the type of computer system 900. For example, system memory 910 may be volatile memory (such as random access memory (RAM)) and/or non-volatile memory (such as read-only memory (ROM), flash memory, etc.). Different types of RAM configurations may be provided, including a static random access memory (SRAM), a dynamic random access memory (DRAM), and others. In some implementations, system memory 910 may include a basic input/output system (BIOS) including basic routines that help to transfer information between elements within computer system 900 such as during start-up.

Computer-readable storage media 922 may represent remote, local, fixed, and/or removable storage devices plus storage media for temporarily and/or more permanently including and storing computer-readable information for use by computer system 900, including instructions executable by processing unit 904 of computer system 900.

Computer-readable storage media 922 can include any appropriate media known or used in the field, including storage media and communication media, such as but not limited to volatile and non-volatile, removable and non-removable media implemented in any method or technology for storage and/or transmission of information. This can include tangible, computer-readable storage media, such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible, computer-readable media.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk, such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include solid-state drives (SSD) based on non-volatile memory, such as flash-memory based SSDs, enterprise flash drives, solid state ROM, and the like, SSDs based on volatile memory, such as solid state RAM, dynamic RAM, static RAM, DRAM-based SSDs, magneto-resistive RAM (MRAM) SSDs, and hybrid SSDs that use a combination of DRAM and flash memory based SSDs. The disk drives and their associated, computer-readable media may provide non-volatile storage of computer-readable instructions, data structures, program modules, and other data for computer system 900.

Machine-readable instructions executable by one or more processors or cores of processing unit 904 may be stored on a non-transitory, computer-readable storage medium. A non-transitory, computer-readable storage medium can include physically tangible memory or storage devices that include volatile memory storage devices and/or non-volatile storage devices. Examples of non-transitory, computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments, communications subsystem 924 can include radio frequency (RF) transceiver components to access wireless voice and/or data networks (e.g., using cellular telephone technology, advanced data network technology, such as 3G, 4G, or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real time from users of social networks and/or other communication services, such as Twitter® feeds, Facebook® updates, web feeds, such as Rich Site Summary (RSS) feeds, and/or real-time updates from one or more third party information sources.

Additionally, communications subsystem 924 may be configured to receive data in the form of continuous data streams. The continuous data streams may include event streams 928 of real-time events and/or event updates 930 that may be continuous or unbounded in nature with no explicit end. Examples of applications that generate continuous data may include sensor data applications, financial tickers, network performance measuring tools (e.g., network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in FIG. 9 is intended as a non-limiting example. Many other configurations having more or fewer components than the system depicted in FIG. 9 are possible. For example, customized hardware might also be used and/or particular elements might be implemented in hardware, firmware, software (including applets), or a combination. Furthermore, connection to other computing devices, such as network input/output devices, may be employed. Based on the disclosure and teachings provided herein, a person of ordinary skill in the art will appreciate other ways and/or methods to implement the various embodiments.

### 9. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of patent protection, and what is intended by the applicants to be the scope of patent protection, is the literal and equivalent scope of the set of claims that issue from this application, in the specific form in which such claims issue, including any subsequent correction.

What is claimed is:

1. A method comprising:
identifying a target cloud resource to be protected;
responsive to identifying the target cloud resource to be protected:
identifying a first physical computing device that executes and/or stores at least part of the target cloud resource;
mapping the first physical computing device to a first set of one or more physical security devices that can be configured to provide physical security to the first physical computing device that executes and/or stores at least part of the target cloud resource; and
applying a first physical security action to configure the first set of one or more physical security devices to provide a level of protection to the first physical computing device that executes and/or stores at least part of the target cloud resource, wherein the method is performed by at least one device comprising a hardware processor.

2. The method of claim 1, further comprising:
subsequent to applying the first physical security action:
detecting a migration of the target cloud resource from the first physical computing device to a second physical computing device that executes and/or stores at least part of the target cloud resource;
responsive to detecting the migration of the target cloud resource:
mapping the second physical computing device to a second set of one or more physical security devices that can be configured to provide physical security to the second physical computing device that executes and/or stores at least part of the target cloud resource;
applying a second physical security action to configure the second set of one or more physical security devices to provide the level of protection to the second physical computing device that executes and/or stores at least part of the target cloud resource; and
reversing an impact of the first physical security action on the first set of one or more physical security devices.

3. The method of claim 1, further comprising:
subsequent to applying the first physical security action:
detecting a physical movement of the first physical computing device from a first physical location to a second physical location;
responsive to detecting the physical movement of the first physical computing device:
remapping the first physical computing device to a second set of one or more physical security devices that can provide physical security to first physical security device while the first physical security device is located at the second physical location;
applying a second physical security action to configure the second set of one or more physical security devices to provide the level of protection to the first physical computing device that executes and/or stores at least part of the target cloud resource; and
reversing an impact of the first physical security action on the first set of one or more physical security devices.

4. The method of claim 1, wherein mapping the first physical computing device to the first set of one or more physical security devices comprises:
determining a first physical location where the first physical computing device is located;
identifying a first physical pathway leading to the first physical location of the first physical computing device;
identifying a first set of one or more locking mechanisms corresponding to a first set of one or more access points that intersect the first physical pathway leading to the first physical location of the first physical computing device; and
mapping the first physical computing device to the first set of one or more locking mechanisms.

5. The method of claim 4, wherein applying the first physical security action to configure the first set of one or more physical security devices to provide the level of protection to the first physical computing device comprises at least one of:
(a) engaging or disengaging a first locking mechanism of the first set of one or more locking mechanisms; or
(b) granting a user that is authorized to access the first physical computing device permission to engage and/or disengage the first locking mechanism of the first set of one or more locking mechanisms.

6. The method of claim 4, wherein mapping the first physical computing device to the one or more physical security devices further comprises:
identifying at least one of:
(a) a first set of one or more alarm mechanisms that can monitor at least one of: a physical state of the first physical computing device, the first physical location of the first physical computing device, or the first physical pathway leading to the first physical location of the first physical computing device; or
(b) a first set of one or more surveillance mechanisms that can monitor at least one of: the physical state of the first physical computing device, the first physical location of the first physical computing device, or the first physical pathway leading to the first physical location of the first physical computing device; and
mapping the first physical computing device to at least one of:
(a) the first set of one or more alarm mechanisms; or
(b) the first set of one or more surveillance mechanisms.

7. The method of claim 6, wherein applying the first physical security action to configure the first set of one or more physical security devices to provide the level of protection to the first physical computing device comprises at least one of:
(a) arming or disarming a first alarm mechanism of the first set of one or more alarm mechanisms;
(b) granting a user that is authorized to access the first physical computing device permission to arm and/or disarm the first alarm mechanism;
(c) activating or deactivating a first surveillance device of the first set of one or more surveillance devices;
(d) reorientating the first surveillance device to view the first physical location of the first physical computing device; or
(e) granting the user that is authorized to access the first physical computing device permission to monitor the first physical computing device through the first surveillance device.

8. The method of claim 1:
wherein the first physical computing device and the first set of one or more physical security devices are comprised within a physical environment;
wherein the first set of one or more physical security devices are a subset of a plurality of physical security devices that are comprised within the physical environment;
wherein mapping the first physical computing device to the first set of one or more physical security devices comprises:
determining a first physical location in the physical environment where the first physical computing device is located;
accessing a physical security model of physical environment, the physical security model indicating associations between physical locations in the physical environment and physical security devices that can be configured to provide physical security to the physical locations; and
based on the physical security model of the physical environment indicating an association between the first physical location and a first physical security device, mapping the first physical computing device to the first physical security device; and
wherein the first physical security device is (a) a locking mechanisms that can restrict physical access to the first physical computing device or (b) an alarm mechanism or surveillance mechanism that can monitor physical access to the first physical location of the first physical computing device.

9. The method of claim 1, further comprising:
subsequent to applying the first physical security action:
receiving a request from an entity associated with the target cloud resource for physical access to the first physical computing device;
responsive to receiving the request from the entity, selecting a first physical pathway leading to a first physical location of the first physical computing device that the entity should be permitted to traverse to physically access the first physical computing device;
identifying at least one of:
(a) a first set of one or more locking mechanisms corresponding to a first set of one or more access points that intersect the first physical pathway leading to the first physical location of the first physical computing device;
(b) a first set of one or more alarm mechanisms that monitor the first physical pathway leading to the first physical location of the first physical computing device; and
applying a second physical security action to at least a subset of the first set of one or more physical security devices to provide the entity with physical access to the first physical computing device, wherein applying the second physical security action comprises at least one of:
(a) disengaging the first set of one or more locking mechanisms;
(b) disarming the first set of one or more alarm mechanisms;
(c) granting the entity permission to engage and/or disengage the first set of one or more locking mechanisms; or
(d) granting the entity permission to arm and/or disarm the first set of one or more alarm mechanisms.

10. One or more non-transitory computer-readable media comprising instructions that, when executed by one or more hardware processors, cause performance of operations comprising:
identifying a target cloud resource to be protected;
responsive to identifying the target cloud resource to be protected:
identifying a first physical computing device that executes and/or stores at least part of the target cloud resource;
mapping the first physical computing device to a first set of one or more physical security devices that can be configured to provide physical security to the first physical computing device that executes and/or stores at least part of the target cloud resource; and
applying a first physical security action to configure the first set of one or more physical security devices to provide a level of protection to the first physical computing device that executes and/or stores at least part of the target cloud resource.

11. The one or more non-transitory computer-readable media of claim 10, wherein the operations further comprise:
subsequent to applying the first physical security action:
detecting a migration of the target cloud resource from the first physical computing device to a second physical computing device that executes and/or stores at least part of the target cloud resource;
responsive to detecting the migration of the target cloud resource:
mapping the second physical computing device to a second set of one or more physical security devices that can be configured to provide physical security to the second physical computing device that executes and/or stores at least part of the target cloud resource;
applying a second physical security action to configure the second set of one or more physical security devices to provide the level of protection to the second physical computing device that executes and/or stores at least part of the target cloud resource; and
reversing an impact of the first physical security action on the first set of one or more physical security devices.

12. The one or more non-transitory computer-readable media of claim 10, wherein the operations further comprise:
subsequent to applying the first physical security action:
detecting a physical movement of the first physical computing device from a first physical location to a second physical location;
responsive to detecting the physical movement of the first physical computing device:
remapping the first physical computing device to a second set of one or more physical security devices that can provide physical security to first physical security device while the first physical security device is located at the second physical location;
applying a second physical security action to configure the second set of one or more physical security devices to provide the level of protection to the first physical computing device that executes and/or stores at least part of the target cloud resource; and
reversing an impact of the first physical security action on the first set of one or more physical security devices.

13. The one or more non-transitory computer-readable media of claim 10, wherein mapping the first physical computing device to the first set of one or more physical security devices comprises:
determining a first physical location where the first physical computing device is located;
identifying a first physical pathway leading to the first physical location of the first physical computing device;
identifying a first set of one or more locking mechanisms corresponding to a first set of one or more access points that intersect the first physical pathway leading to the first physical location of the first physical computing device; and
mapping the first physical computing device to the first set of one or more locking mechanisms.

14. The one or more non-transitory computer-readable media of claim 13, wherein applying the first physical security action to configure the first set of one or more physical security devices to provide the level of protection to the first physical computing device comprises at least one of:
(a) engaging or disengaging a first locking mechanism of the first set of one or more locking mechanisms; or
(b) granting a user that is authorized to access the first physical computing device permission to engage and/or disengage the first locking mechanism of the first set of one or more locking mechanisms.

15. The one or more non-transitory computer-readable media of claim 13, wherein mapping the first physical computing device to the one or more physical security devices further comprises:
identifying at least one of:
(a) a first set of one or more alarm mechanisms that can monitor at least one of: a physical state of the first physical computing device, the first physical location of the first physical computing device, or the first physical pathway leading to the first physical location of the first physical computing device; or
(b) a first set of one or more surveillance mechanisms that can monitor at least one of: the physical state of the first physical computing device, the first physical location of the first physical computing device, or the first physical pathway leading to the first physical location of the first physical computing device; and
mapping the first physical computing device to at least one of:
(a) the first set of one or more alarm mechanisms; or
(b) the first set of one or more surveillance mechanisms.

16. The one or more non-transitory computer-readable media of claim 15, wherein applying the first physical security action to configure the first set of one or more physical security devices to provide the level of protection to the first physical computing device comprises at least one of:
(a) arming or disarming a first alarm mechanism of the first set of one or more alarm mechanisms;
(b) granting a user that is authorized to access the first physical computing device permission to arm and/or disarm the first alarm mechanism;
(c) activating or deactivating a first surveillance device of the first set of one or more surveillance devices;
(d) reorientating the first surveillance device to view the first physical location of the first physical computing device; or
(e) granting the user that is authorized to access the first physical computing device permission to monitor the first physical computing device through the first surveillance device.

17. The one or more non-transitory computer-readable media of claim 10:
wherein the first physical computing device and the first set of one or more physical security devices are comprised within a physical environment;
wherein the first set of one or more physical security devices are a subset of a plurality of physical security devices that are comprised within the physical environment;
wherein mapping the first physical computing device to the first set of one or more physical security devices comprises:
determining a first physical location in the physical environment where the first physical computing device is located;
accessing a physical security model of physical environment, the physical security model indicating associations between physical locations in the physical environment and physical security devices that can be configured to provide physical security to the physical locations; and
based on the physical security model of the physical environment indicating an association between the first physical location and a first physical security device, mapping the first physical computing device to the first physical security device; and
wherein the first physical security device is (a) a locking mechanisms that can restrict physical access to the first physical computing device or (b) an alarm mechanism or surveillance mechanism that can monitor physical access to the first physical location of the first physical computing device.

18. The one or more non-transitory computer-readable media of claim 10, wherein the operations further comprise:
subsequent to applying the first physical security action:
receiving a request from an entity associated with the target cloud resource for physical access to the first physical computing device;
responsive to receiving the request from the entity, selecting a first physical pathway leading to a first physical location of the first physical computing device that the entity should be permitted to traverse to physically access the first physical computing device;
identifying at least one of:
(a) a first set of one or more locking mechanisms corresponding to a first set of one or more access points that intersect the first physical pathway leading to the first physical location of the first physical computing device;
(b) a first set of one or more alarm mechanisms that monitor the first physical pathway leading to the first physical location of the first physical computing device; and
applying a second physical security action to at least a subset of the first set of one or more physical security devices to provide the entity with physical access to the first physical computing device, wherein applying the second physical security action comprises at least one of:
(a) disengaging the first set of one or more locking mechanisms;
(b) disarming the first set of one or more alarm mechanisms;
(c) granting the entity permission to engage and/or disengage the first set of one or more locking mechanisms; or
(d) granting the entity permission to arm and/or disarm the first set of one or more alarm mechanisms.

19. A system comprising:
one or more hardware processors;
one or more non-transitory computer-readable media; and
program instructions stored on the one or more non-transitory computer-readable media that, when executed by the one or more hardware processors, cause operations comprising:
identifying a target cloud resource to be protected;
responsive to identifying the target cloud resource to be protected:
identifying a first physical computing device that executes and/or stores at least part of the target cloud resource;
mapping the first physical computing device to a first set of one or more physical security devices that can be configured to provide physical security to the first physical computing device that executes and/or stores at least part of the target cloud resource; and
applying a first physical security action to configure the first set of one or more physical security devices to provide a level of protection to the first physical computing device that executes and/or stores at least part of the target cloud resource.

20. The system of claim 19, wherein the operations further comprise:
subsequent to applying the first physical security action:
detecting a migration of the target cloud resource from the first physical computing device to a second physical computing device that executes and/or stores at least part of the target cloud resource;
responsive to detecting the migration of the target cloud resource:
mapping the second physical computing device to a second set of one or more physical security devices that can be configured to provide physical security to the second physical computing device that executes and/or stores at least part of the target cloud resource;
applying a second physical security action to configure the second set of one or more physical security devices to provide the level of protection to the second physical computing device that executes and/or stores at least part of the target cloud resource; and
reversing an impact of the first physical security action on the first set of one or more physical security devices.
